(19) United States
(12) Patent Application Publication
(10) Pub. No.: US 2025/0081241 A1
(43) Pub. Date: Mar. 6, 2025

(54) UPLINK MULTI-USER OPERATIONAL ENHANCEMENTS FOR LOW LATENCY APPLICATIONS

(71) Applicant: Apple Inc., Cupertino, CA (US)

(72) Inventors: Chittabrata Ghosh, Fremont, CA (US); Anuj Batra, Redwood City, CA (US); Oren Shani, Saratoga, CA (US)

(21) Appl. No.: 18/821,657

(22) Filed: Aug. 30, 2024

Related U.S. Application Data
(60) Provisional application No. 63/536,027, filed on Aug. 31, 2023.
(60) Provisional application No. 63/543,694, filed on Oct. 11, 2023.

(51) Int. Cl. H04W 74/0816; H04L 1/1607; H04W 60/04; H04W 74/00

(52) U.S. Cl. CPC H04W 74/0816; H04L 1/1635; H04W 60/04; H04W 74/002

(57) ABSTRACT

A method performed by a wireless device operating in an uplink multi-user mode is described. The method includes determining that a condition exists to prompt the wireless device to transmit an unsolicited low latency presence frame to an access point to solicit transmission of a solicited control frame from the access point; transmitting the unsolicited low latency presence frame to the access point, the unsolicited low latency presence frame indicating a type of solicited control frame requested by the wireless device; receiving a solicited control frame from the access point, the solicited control frame comprising information relating to the unsolicited low latency presence frame; and performing an action based on the received solicited control frame.

### CROSS-REFERENCE TO RELATED APPLICATIONS

This application claims the benefit of U.S. Provisional Patent Application No. 63/536,027, filed Aug. 31, 2023, and U.S. Provisional Patent Application No. 63/543,694, filed Oct. 11, 2023, both of which are incorporated herein by reference.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point that provides one or more stations (STAs) with access to another network, such as the Internet. There are many generations of the IEEE 802.11 standard, including 802.11ax (Wi-Fi 6) and 802.11be (Wi-Fi 7).

IEEE 802.11 is a packet-based protocol. Under this protocol, a transmitter, e.g., an access point (AP), packages control information and/or user data into a protocol data unit (PDU) in a physical layer convergence protocol (PLCP). The physical layer PDU (PPDU) includes a preamble and a data field, among other fields. After generating the PPDU, the access point can send the PPDU to a station connected to the access point. Communication from the access point to a station is referred to as the downlink, and the communication from a station to the access point is referred to as the uplink.

### SUMMARY

In accordance with the present disclosure, a method performed by a wireless device operating in an uplink multi-user mode can include determining that the wireless electronic device has low latency data to transmit to an access point (AP) using the uplink multi-user mode, wherein the low latency data corresponds to a type defined by an access category (AC) or traffic identifier (TID) excluded from uplink multi-user mode; setting an exclusion bit in an operating mode control subfield of a transmit operating mode indicator frame, the exclusion bit indicating the exclusion of one AC or one TID from the uplink multi-user mode; sending a trigger-based PPDU to the AP, wherein the trigger-based PPDU comprises the transmit operating mode indicator frame; contending for channel access to send the low latency data on the uplink using enhanced distributed channel access (EDCA) function in accordance with one or more EDCA parameters; and transmitting the low latency data to the AP using a single user PPDU in accordance with the EDCA-based channel contention.

In some implementations, the operating mode control subfield includes a bit field for one or more ACs.

In some implementations, the operating mode control subfield includes a bit field for one or more TIDs.

In some implementations, the method further includes excluding traffic in the AC or with the TID from using trigger-based uplink multi-user mode transmissions based on the bit set in the operating mode control subfield.

In some implementations, the method further includes transmitting traffic in the AC or with the TID using a single-user mode transmission scheme based on the bit set in the operating mode control subfield.

In some implementations, an uplink multi-user disable bit of the operating mode control subfield is set to 1 to indicate that uplink multi-user transmissions are disabled.

In some implementations, the operating mode control subfield includes a bit map for ACs as follows:

| AC Bit | |
|---|---|
| Field | Interpretation |
| B0 = 1 | Trigger-based uplink multi-user (UL MU) transmissions for |
| | AC background are suspended by wireless electronic device; |
| | UL MU operation allowed for other ACs. |
| B1 = 1 | Trigger-based uplink multi-user (UL MU) transmissions for |
| | AC best effort are suspended by wireless electronic device; UL |
| | MU operation allowed for other ACs. |
| B2 = 1 | Trigger-based uplink multi-user (UL MU) transmissions for |
| | AC video are suspended by wireless electronic device; |
| | UL MU operation allowed for other ACs. |
| B3 = 1 | Trigger-based uplink multi-user (UL MU) transmissions for |
| | AC voice are suspended by wireless electronic device; UL MU |
| | operation allowed for other ACs. |

In some implementations, the operating mode control subfield includes a bit map for TIDs as follows:

| TID Bit | |
|---|---|
| Field | Interpretation |
| B0 = 1 | Trigger-based uplink multi-user (UL MU) transmissions for |
| | TID 0 are suspended by wireless electronic device; UL MU |
| | operation allowed for other TIDs. |
| B1 = 1 | Trigger-based uplink multi-user (UL MU) transmissions for |
| | TID 1 are suspended by wireless electronic device; UL MU |
| | operation allowed for other TIDs. |
| B2 = 1 | Trigger-based uplink multi-user (UL MU) transmissions for |
| | TID 2 are suspended by wireless electronic device; UL MU |
| | operation allowed for other TIDs. |
| B3 = 1 | Trigger-based uplink multi-user (UL MU) transmissions for |
| | TID 3 are suspended by wireless electronic device; UL MU |
| | operation allowed for other TIDs. |
| B4 = 1 | Trigger-based uplink multi-user (UL MU) transmissions for |
| | TID 4 are suspended by wireless electronic device; UL MU |
| | operation allowed for other TIDs. |
| B5 = 1 | Trigger-based uplink multi-user (UL MU) transmissions for |
| | TID 5 are suspended by wireless electronic device; UL MU |
| | operation allowed for other TIDs. |
| B6 = 1 | Trigger-based uplink multi-user (UL MU) transmissions for |
| | TID 6 are suspended by wireless electronic device; UL MU |
| | operation allowed for other TIDs. |
| B7 = 1 | Trigger-based uplink multi-user (UL MU) transmissions for |
| | TID 7 are suspended by wireless electronic device; UL MU |
| | operation allowed for other TIDs. |

In some implementations, an uplink multi-user data disable bit of the operating mode control subfield is set to 1 to indicate that uplink multi-user transmissions are disabled.

In some implementations, the operating mode control subfield includes a bit map for ACs as follows:

| AC Bit | |
|---|---|
| Field | Interpretation |
| B0 = 1 | Basic trigger-based uplink multi-user transmissions for AC |
| | background are suspended by wireless electronic device; UL |
| | MU operation allowed for other ACs. |
| B1 = 1 | Basic trigger-based uplink multi-user transmissions for AC |
| | best effort are suspended by wireless electronic device; UL |
| | MU operation allowed for other ACs. |
| B2 = 1 | Basic trigger-based uplink multi-user transmissions for AC |
| | video are suspended by wireless electronic device; UL MU |
| | operation allowed for other ACs. |
| B3 = 1 | Basic trigger-based uplink multi-user transmissions for AC |
| | voice are suspended by wireless electronic device; UL MU |
| | operation allowed for other ACs. |

In some implementations, the operating mode control subfield includes a bit map for TIDs as follows:

| TID Bit | |
|---|---|
| Field | Interpretation |
| B0 = 1 | Basic trigger-based uplink multi-user (UL MU) transmissions |
| | for TID 0 are suspended by wireless electronic device; UL MU |
| | operation allowed for other TIDs. |
| B1 = 1 | Basic trigger-based uplink multi-user (UL MU) transmissions |
| | for TID 1 are suspended by wireless electronic device; UL MU |
| | operation allowed for other TIDs. |
| B2 = 1 | Basic trigger-based uplink multi-user (UL MU) transmissions |
| | for TID 2 are suspended by wireless electronic device; UL MU |
| | operation allowed for other TIDs. |
| B3 = 1 | Basic trigger-based uplink multi-user (UL MU) transmissions |
| | for TID 3 are suspended by wireless electronic device; UL MU |
| | operation allowed for other TIDs. |
| B4 = 1 | Basic trigger-based uplink multi-user (UL MU) transmissions |
| | for TID 4 are suspended by wireless electronic device; UL MU |
| | operation allowed for other TIDs. |
| B5 = 1 | Basic trigger-based uplink multi-user (UL MU) transmissions |
| | for TID 5 are suspended by wireless electronic device; UL MU |
| | operation allowed for other TIDs. |
| B6 = 1 | Basic trigger-based uplink multi-user (UL MU) transmissions |
| | for TID 6 are suspended by wireless electronic device; UL MU |
| | operation allowed for other TIDs. |
| B7 = 1 | Basic trigger-based uplink multi-user (UL MU) transmissions |
| | for TID 7 are suspended by wireless electronic device; UL MU |
| | operation allowed for other TIDs. |

Some implementations can include identifying a preferred AC or preferred TID and informing the access point of the preferred AC or preferred TID; determining a presence of low latency traffic queued for uplink transmission, the low latency traffic in the preferred AC or with the preferred TID; transmitting a control frame to the access point, the control frame including an indication of an amount of low latency traffic queued for uplink transmission and an identification of the AC or TID for the low latency traffic, the control frame being a request for uplink resources to transmit the low latency traffic; receiving a solicited trigger frame from the access point, the solicited trigger frame including either 1) acknowledgement of the control frame and an identification of uplink resources for transmitting the low latency traffic or 2) an acknowledgement of the control frame without an identification of uplink resources for transmitting the low latency traffic; and transmitting the low latency traffic using the uplink resources identified in the solicited trigger frame.

Some implementations can include receiving a block acknowledgement from the access point after transmitting the low latency traffic, the block acknowledgement including a multi-user enhanced distributed channel access (MU-EDCA) parameter reset, and the method includes resetting at least one MU-EDCA parameter.

Some implementations can include receiving a block acknowledgement from the access point and, after receiving the block acknowledgement, receiving an MU-EDCA reset frame from the access point.

In some implementations, the MU-EDCA parameter reset includes an MU-EDCA timer reset, and the method includes resetting the MU-EDCA timer.

Some implementations can include resetting one or more MU-EDCA parameters, including the MU-EDCA timer, and operating in an EDCA mode based on the EDCA parameters for at least the preferred access category identified in the control frame of the low latency traffic associated with the block acknowledgement.

In some implementations, the solicited trigger frame includes a bit field for acknowledging the control frame, and the bit field for acknowledging the control frame being set to zero for acknowledging the control frame without providing uplink resources and the bit field being set to one for acknowledging the control frame and also providing uplink resources.

In some implementations, the solicited trigger frame includes a basic trigger frame, and wherein the bit field for acknowledging the control frame in the basic trigger frame is a uplink length subfield.

In some implementations, the solicited trigger frame further includes an ultra-high reliability mode trigger subfield that can indicate that the solicited trigger frame is an MU-EDCA Reset trigger frame (MR-TF).

In some implementations, the control frame includes a low latency buffer status field, the low latency buffer status field including subfields for one or more of low latency AC or TID, scaling factor, or low latency traffic queue size.

In some implementations, the control frame includes one low latency buffer status field for each preferred access category for which the wireless device has queued low latency traffic.

In some implementations, the control frame represents an attempt to solicit a trigger frame during a short interframe space (SIFS) time period.

In some implementations, the control frame is an unsolicited low latency presence frame.

In accordance with aspects of the present disclosure, a method performed by a wireless device operating in an uplink multi-user mode can include identifying a preferred AC or preferred TID, and informing the access point of the preferred AC or preferred TID; determining a presence of low latency traffic queued for uplink transmission, the low latency traffic in the preferred AC or with the preferred TID; transmitting an unsolicited low latency presence frame to the access point, the unsolicited low latency presence frame including an indication of an amount of low latency traffic queued for uplink transmission and an identification of the AC or TID for the low latency traffic, the unsolicited low latency presence frame being a request for uplink resources to transmit the low latency traffic; receiving a solicited trigger frame from the access point, the solicited trigger frame including either 1) acknowledgement of the unsolicited low latency presence frame and an identification of uplink resources for transmitting the low latency traffic or 2) an acknowledgement of the unsolicited low latency presence frame without an identification of uplink resources for transmitting the low latency traffic; and transmitting the low latency traffic using the uplink resources identified in the solicited trigger frame.

Some implementations can include receiving a block acknowledgement from the access point after transmitting the low latency traffic, the block acknowledgement including a MU-EDCA parameter reset, and the method includes resetting at least one MU-EDCA parameter.

In some implementations, the MU-EDCA parameter reset includes an MU-EDCA timer reset, and the method includes resetting the MU-EDCA timer.

In some implementations, the MU-EDCA parameter reset causes the wireless device to enter into a deferred contention mode.

Some implementations can include resetting one or more MU-EDCA parameters and operating in an EDCA mode based on the EDCA parameters for at least the preferred access category identified in the control frame of the low latency traffic associated with the block acknowledgement.

In some implementations, the solicited trigger frame includes a bit field for acknowledging the unsolicited low latency presence frame, and the bit field for acknowledging the unsolicited low latency presence frame being set to zero for acknowledging the unsolicited low latency presence frame without providing uplink resources and the bit field being set to one for acknowledging the unsolicited low latency presence frame and also providing uplink resources.

In some implementations, the solicited trigger frame includes a basic trigger frame, and the bit field for acknowledging the unsolicited low latency presence frame in the basic trigger frame is an uplink length subfield.

In some implementations, the solicited trigger frame further includes an ultra-high reliability mode trigger subfield that can indicate that the solicited trigger frame is an MU-EDCA trigger frame (MR-TF).

In some implementations, the unsolicited low latency presence frame includes a low latency buffer status field, the low latency buffer status field including subfields for one or more of low latency AC or TID, scaling factor, and low latency traffic queue size.

In some implementations, the unsolicited low latency presence frame includes one low latency buffer status field for each preferred access category for which the wireless device has queued low latency traffic.

In some implementations, the unsolicited low latency presence frame includes a solicitation for a trigger frame within a SIFS time period.

In some implementations, the unsolicited low latency presence frame includes a solicitation to begin a solicited trigger mode (STM).

Aspects of the present disclosure pertain to methods performed by an access point, including receiving, from a wireless device, an unsolicited low latency presence (U-LLP) frame indicating a presence of low latency traffic for uplink transmission by a wireless device operating in multi-user enhanced distributed channel access (MU-EDCA) operating mode, the U-LLP identifying an access category (AC) or traffic identifier (TID) for the low latency traffic for uplink transmission and an amount of low latency traffic for uplink transmission; determining that the AC or TID is a pre-negotiated preferred AC or TID for the wireless device; determining whether the access point is available for uplink scheduling; if the access point is available for uplink scheduling for the wireless device, transmitting a solicited trigger frame to the wireless device that includes an acknowledgement of the U-LLP and a resource allocation for the wireless device to use to transmit the low latency traffic for uplink transmission; and if the access point is not available for uplink scheduling for the wireless device, transmitting an acknowledgement to the wireless device without a resource allocation.

In some implementations, the acknowledgement transmitted to the wireless device without the resource allocation is within a solicited trigger frame.

In some implementations, the solicited trigger frame is an MU-EDCA Reset trigger frame (MR-TF).

In some implementations, the MR-TF includes a basic trigger frame and additional bit fields for ultra-high reliability (UHR) trigger to indicate that the basic trigger frame is an MR-TF.

In some implementations, the solicited trigger frame includes a bit field to indicate one or more of trigger type, an acknowledgement of the U-LLP, approval or denial of solicited trigger mode, and resource allocation.

Some implementations include transmitting an MU-EDCA parameter reset in the solicited trigger frame.

Some implementations include receiving a trigger based (TB) PPDU from the wireless device with the low latency traffic of the preferred AC or preferred TID on the resources allocated to the wireless device by the solicited trigger frame.

Some implementations include transmitting a multi-station block acknowledgement (M-STA BA) to the wireless device to acknowledge receipt of the TB PPDU.

In some implementations, the M-STA BA includes an MU-EDCA parameter reset.

Some implementations include transmitting an MU-EDCA parameter reset to the wireless device after transmitting the M-STA BA.

In some implementations, the access point receiving the U-LLP triggers the access point to transmit at least an acknowledgement of the U-LLP to the wireless device during an MU-EDCA deferred contention period (while an MU-EDCA timer is running).

In some implementations, the access point receiving the U-LLP triggers the access point to transmit at least an acknowledgement of the U-LLP to the wireless device during an MU-EDCA deferred contention period within a short interframe space (SIFS) period of time.

In some implementations, the access point receiving the U-LLP triggers the access point to transmit a trigger frame with an acknowledgement to the wireless device during an MU-EDCA deferred contention period (while an MU-EDCA timer is running).

In some implementations, the access point receiving the U-LLP triggers the access point to transmit a trigger frame with an acknowledgement to the wireless device during an MU-EDCA deferred contention period within a short interframe space (SIFS) period of time.

In some implementations, the U-LLP is a request by the wireless device to begin a solicited trigger mode (STM).

In some implementations, the solicited trigger frame includes a bit field to indicate the approval or denial of the STM for the wireless device.

Aspects of the embodiments are directed to methods performed by a wireless device operating in an uplink multi-user mode, including determining that a condition exists to prompt the wireless device to transmit an unsolicited low latency presence frame to an access point to solicit a solicited control frame to be sent to the wireless device from the access point; transmitting the unsolicited low latency presence frame to the access point, the unsolicited low latency presence frame including an indication of a type of solicited control frame requested by the wireless device; receiving a solicited control frame from the access point, the solicited control frame including information in response to the indication in the unsolicited low latency presence frame; and performing an action based on the received solicited control frame.

In some implementations, the condition includes the wireless device having received low latency data for transmission associated with an access category (AC) or traffic identifier (TID) that is exempted from EDCA operation, the wireless device having received the low latency uplink data during a TXOP for the access point; and wherein the unsolicited low latency presence frame is transmitted with a Block acknowledgement in response to receiving a downlink data unit from the access point during the TXOP, and wherein the unsolicited low latency presence frame includes an indication of the access category of the low latency data for transmission.

Some implementations include receiving, from the access point, a trigger frame (TF) for the AC or TID identified in the unsolicited low latency presence frame, the TF initiating an opportunity for the wireless device to transmit the low latency data.

In some implementations, the condition includes the wireless device having received a data unit from the access point and the wireless device having determined that a channel quality between the wireless device and the access point is below a threshold; and operations include configuring a block acknowledgement with multiple zeros to indicate poor channel quality, configuring the unsolicited low latency presence frame to request sounding from the access point, and sending the unsolicited low latency presence frame with the block acknowledgment to the access point in response to receiving the data unit.

Some implementations include receiving, from the access point, a null data packet (NDP) announcement; receiving, from the access point, a sounding NDP; and transmitting, to the access point, a channel quality indicator based on one or more characteristics of the detected sounding NDP.

In some implementations, the sounding NDP is received after a SIFS period.

In some implementations, the NDP announcement includes a single unit information field for single-user mode or multiple user information fields for multi-user mode.

Some implementations include receiving, after receiving the sounding NDP, a beamforming report poll (BFRP) trigger message.

Some implementations include transmitting, to the access point, a channel quality indicator based on the characteristics of the detected sounding NDP and information in the BFRP trigger message.

In some implementations, the condition includes the wireless device determining to initiate ranging or sensing; the operations including configuring the unsolicited low latency presence frame with information to request a solicited sensing or ranging polling trigger frame; and sending the unsolicited low latency presence frame with information to request a solicited sensing or ranging polling trigger frame to the access point; receiving, in response to the unsolicited low latency presence frame sent to the access point, a ranging or sensing polling trigger frame; and sending, in response to receiving the ranging or sensing polling trigger frame, a clear-to-send (CTS) message to the access point.

In some implementations, sending the CTS message to the access point causes the access point to send a ranging or sensing null data packet (NDP) announcement (NDPA) frame to the wireless device and/or other stations in proximity to the wireless device and a Sensing Initiator to Sensing Responder (SI2SR) NDP to one or more other stations in proximity to the wireless device.

Some implementations include receiving a ranging or sensing a Sensing Initiator to Sensing Responder (SI2SR) sounding trigger frame from the access point; and sending an SI2SR NDP to the access point.

In some implementations, sending an SI2SR NDP to the access point causes the access point to send a sensing report trigger frame to the wireless device and/or other stations in proximity to the wireless device, which causes the other stations to send sensing measurement reporting frames to the access point.

In some implementations, the CTS message includes a CTS-to-self message.

Some implementations include receiving from the access point, a sensing responder to sounding initiator trigger frame; and sending to the access point a sensing responder to sounding initiator null data packet.

In some implementations, the condition includes the wireless device having received low latency data for transmission, the wireless device having received the low latency uplink data during a TXOP for the access point; and wherein the unsolicited low latency presence frame is transmitted with a Block acknowledgement in response to receiving a downlink data unit from the access point during the TXOP, and wherein the unsolicited low latency presence frame includes an indication requesting a solicited grant of the TXOP.

Some implementations include receiving, from the access point, a solicited grant control frame, the solicited grant control frame granting the wireless device a remaining portion of the TXOP duration; and sending the low latency data during the TXOP.

Aspects of the embodiments are directed to methods performed by an access point, the method including receiving an unsolicited low latency presence frame from a wireless device, the unsolicited low latency presence frame including information indicating a solicitation of a control frame; determining a solicited control frame requested by the wireless device by decoding the unsolicited low latency presence frame; configuring a control frame to send to the wireless device in response to the information in the unsolicited low latency presence frame; and sending the control frame to the wireless device.

In some implementations, the unsolicited low latency presence frame is received during a TXOP for the access point.

In some implementations, the unsolicited low latency presence frame includes a request for a solicited trigger frame.

In some implementations, the unsolicited low latency presence frame includes a request for a TXOP grant.

In some implementations, the unsolicited low latency presence frame includes a request for a control frame to perform sounding.

In some implementations, the unsolicited low latency presence frame includes a request for a control frame to perform sensing or ranging.

Aspects of the implementations are directed to an access point configured to perform one or more operations described above.

Aspects of the implementations are directed to access point configured to perform one or more operations described in the specification.

Aspects of the implementations are directed to wireless device including a processor and memory, and configured to perform any of the method operations described above.

Aspects of the implementations are directed to wireless device configured to perform one or more operations described in the specification.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a block diagram of example of electronic devices communicating wirelessly.

FIG. 2 is a schematic diagram showing an example AP servicing multiple STAs operating in MU-EDCA.

FIG. 3A is a schematic diagram showing first example of selective MU-EDCA exclusion.

FIG. 3B is a schematic diagram showing second example of selective MU-EDCA exclusion.

FIG. 4 is an example process flow diagram for transmitting low latency uplink traffic using an MU-EDCA exclusion process.

FIG. 5A is a schematic diagram illustrating an example of assisted EDCA mode (AEM).

FIG. 5B is a schematic diagram of an MU-EDCA control field format in an MU-EDCA reset frame.

FIG. 6 is a schematic diagram of an example wireless device initiating a solicited trigger mode (STM) with an access point.

FIG. 7A illustrates a flowchart of an example method performed by a wireless device.

FIG. 7B illustrates a flowchart of an example method performed by an access point.

FIG. 8 illustrates a block diagram of an example electronic device.

FIG. 9 is a schematic diagram illustrating use of an unsolicited low latency presence (U-LLP) frame for soliciting a preemption trigger frame.

FIG. 10A is a schematic diagram illustrating use of an unsolicited low latency presence (U-LLP) presence frame for soliciting a control frame for non-Trigger-based sounding.

FIG. 10B is a schematic diagram illustrating use of an unsolicited low latency presence (U-LLP) presence frame for soliciting a control frame for Trigger-based sounding.

FIG. 11 is a schematic diagram illustrating use of an unsolicited low latency presence (U-LLP) presence frame for soliciting a control frame for sensing or ranging.

FIG. 12 is a schematic diagram illustrating use of an unsolicited low latency presence (U-LLP) presence frame for soliciting a control frame for preempting a TXOP grant.

FIG. 13 is a process flowchart for using an unsolicited low latency presence (U-LLP) frame for soliciting a control frame from an access point.

FIG. 14 illustrates an example of a basic TF variant for a solicited TF.

Like reference numerals indicate like components or features.

### DETAILED DESCRIPTION

Enhanced distributed channel access (EDCA) is a mechanism that provides differentiated access to a wireless medium by prioritizing different types of traffic. This helps improve the overall quality of service (QOS) for applications with different constraints, such as voice, video, and data. In EDCA, traffic is classified into four access categories (ACs) with different priority levels and access parameters. These ACs include voice (AC_VO), video (AC_VI), best effort (AC_BE), and background (AC_BK). In some IEEE 802.11 communication protocols (such as 802.11ax) that support multi-user EDCA (MU-EDCA), an access point (AP) can trigger uplink (UL) transmissions from multiple stations (STAs) simultaneously using a trigger frame (TF). This can help avoid the latency associated with contending for access to the wireless medium. However, a STA that transmits UL data in response to a TF may be unable to transmit additional UL data for a period of time defined by an MU-EDCA timer. This can result in a delay of up to 2 seconds, which may be unsuitable for some latency-sensitive applications.

In some cases, the AP can reset the MU-EDCA timer of the STA (thus allowing the STA to transmit additional UL data) by transmitting an MU-EDCA Reset frame to the STA via unicast or broadcast. This can be useful if the AP is aware that the STA has pending low latency (LL) UL data to transmit. However, if the STA is in MU-EDCA mode (e.g., waiting for the MU-EDCA timer to expire), the STA may be unable to notify the AP that new LL UL data has arrived. As such, the AP may be unaware that the STA has pending UL LL data, and may not send an MU-EDCA Reset frame at the appropriate time.

In accordance with aspects of the present disclosure, the STA may transmit an unsolicited low latency presence (U-LLP) frame to inform the AP that the STA has pending UL LL data. The STA can transmit the U-LLP frame after receiving a beacon frame from the AP. The U-LLP frame from the STA may solicit a MU-EDCA Reset Trigger Frame (MR-TF) from the AP. Upon receiving the MR-TF from the AP, the STA may initiate a solicited trigger mode (STM) and transmit the pending UL LL data using resources allocated by the MR-TF. If the AP is unable to respond immediately with an MR-TF, the AP may transmit an acknowledgement (ACK) to indicate that the U-LLP frame was successfully received. When the MR-TF arrives (at a later time), the STA can transmit the UL LL data without contending for access to the wireless medium.

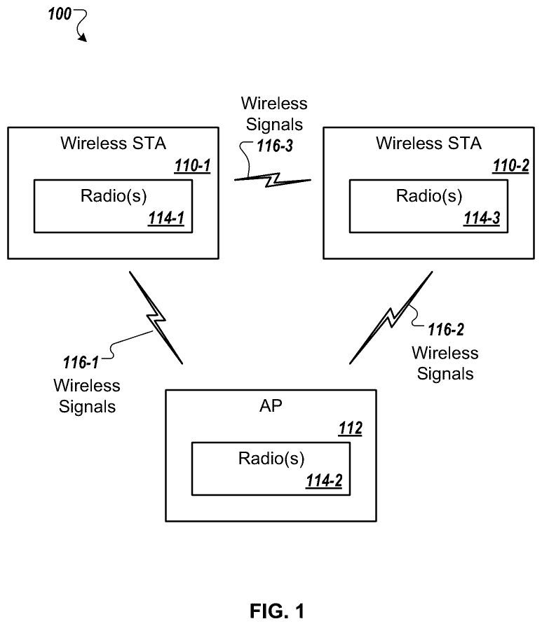

FIG. 1 illustrates a block diagram 100 of an example of wireless stations communicating wirelessly, according to some implementations. Notably, one or more wireless stations 110-1 and 110-2 (collectively, 110) and access point (AP) 112 can communicate wirelessly in a wireless local area network (WLAN) using an IEEE 802.11 communication protocol. Examples of a wireless device 110 can include, but are not limited to, a smartphone, a laptop computer, a notebook computer, a tablet, a smartwatch, a set-top box, a television, a gaming console, a smart home device, or any other such electronic device with a wireless radio for communicating over a Wi-Fi network. Such wireless devices are generally referred to as stations—or STA. Thus, wireless stations 110 can be associated with, or can have a connection with, access point 112. For example, STAs 110 and access point 112 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). A beacon is a recurring time-related management frame message sent from an AP. Note that the access point 112 can provide access to a network, such as the Internet, via an Ethernet protocol, and can be a physical access point or a virtual or “software” access point that is implemented on a computer or an electronic device. In this specification, electronic devices 110 are sometimes referred to as “recipient electronic devices” or “receiver stations.”

Although the environment shown in FIG. 1 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between wireless stations 110.

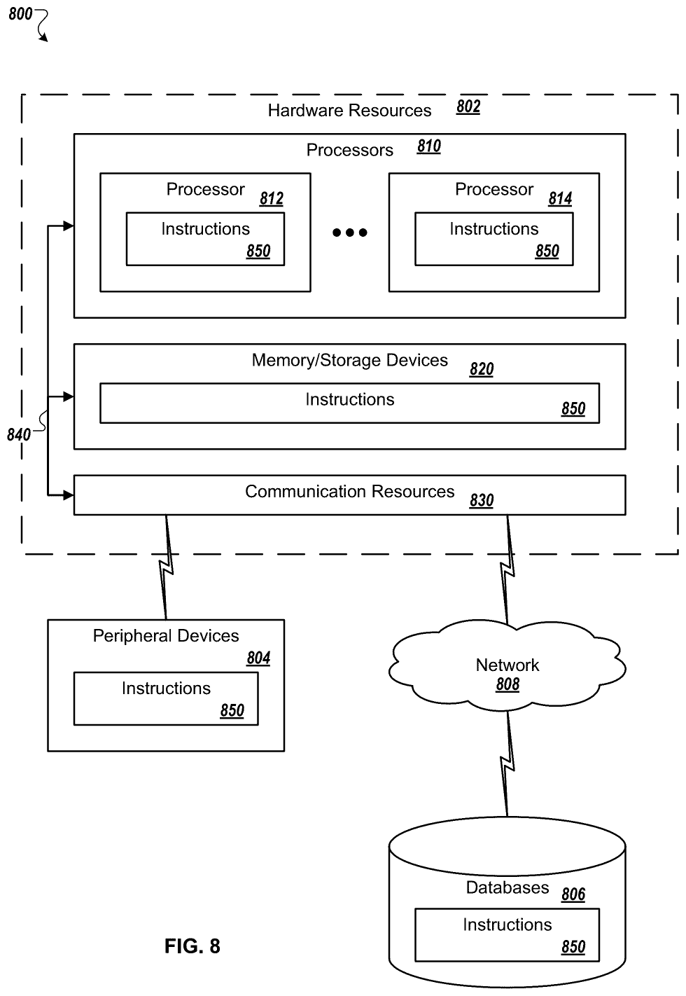

As described further below with reference to FIG. 8, wireless stations 110 and access point 112 can include subsystems, such as a networking subsystem, a memory subsystem, and a processor subsystem. In addition, wireless stations 110 and access point 112 can include radios 114 in the networking subsystems. More generally, electronic devices 110 and access point 112 can include (or can be included within) any electronic devices with networking subsystems that enable wireless stations 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116-1 are communicated between radio 114-1 in wireless station 110-1 and radio 114-2 in access point 112, respectively. For example, as noted previously, wireless station 110-1 and access point 112 can exchange packets or frames using a Wi-Fi communication protocol in a WLAN. Further, one or more radios 114-1 can receive wireless signals 116-1 that are transmitted by one or more radios 114-2 via one or more links between electronic device 110-1 and access point 112. The one or more radios 114-1 can transmit wireless signals 116-1 that are received by the one or more radios 114-2.

The access point 112 can support multiple STAs (or devices) within the WLAN. As shown in FIG. 1, wireless signals 116-2 are communicated between radio 114-3 in wireless station 110-2 and radio 114-2 in access point 112, respectively. For example, as noted previously, wireless station 110-2 and access point 112 can exchange packets or frames using a Wi-Fi communication protocol in the WLAN. Further, one or more radios 114-2 can receive wireless signals 116-2 that are transmitted by one or more radios 114-3 via one or more links between electronic device 110-2 and access point 112. The one or more radios 114-3 can transmit wireless signals 116-2 that are received by the one or more radios 114-2.

In some implementations, one or more radios 114-1 and 114-3 can receive wireless signals that are transmitted by one or more radios 114-2 via one or more links between the electronic devices 110-1 and 110-2, and the access point 112.

In some implementations, wireless station 110-1 can communication directly with wireless station 110-2 using wireless signals 116-3. The radio(s) 114-1 can be configured to perform point-to-point (P2P) or direct communications with radio(s) 114-3.

In some implementations, the access point 112 can group the electronic devices 110 into a target station set. The target station set concept comes from downlink multi-user transmission where the access point 112 can transmit to multiple stations simultaneously in one PPDU, e.g., using Orthogonal Frequency Division Multiple Access (OFDMA) or multiuser (MU) Multiple Input Multiple Output (MU-MIMO). Here, the target station set is a set of stations that can simultaneously be served by the access point 112. The stations in the set do not have to share the same PHY parameters, such as MCS, number of streams, etc.

In some implementations, the access point 112 can simultaneously communicate with a plurality of electronic devices 110 using multiuser (MU) techniques, such as MU Multiple Input Multiple Output (MU-MIMO). In some examples, the access point 112 communicates with the electronic devices 110 using frequency multiplexing, such that the access point 112 allocates to the electronic devices respective portions of the overall bandwidth. For example, to simultaneously communicate with four electronic devices over an 80 Megahertz (MHZ) bandwidth, the access point 112 transmits a MU-PPDU over the 80 MHz bandwidth. The MU-PPDU includes a sub-PPDU for each of the four electronic devices, where each sub-PPDU (or sub-channel) is allocated 20 MHz. The access point 112 can use the MU-PPDU to communicate with devices in the same target set, devices in different target sets, or a combination of both.

In some implementations, access point 112 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUsRUs), which can be allocated to different electronic devices (users). Under the standard, the access point 112 coordinates multiuser OFDMA by broadcasting a trigger frame which, among other things, allocates a RU to each participating electronic device. Each participating electronic device responds to the trigger frame by transmitting a PPDU to the access point 112 using the allocated RU. The trigger frame can also include power control information. The access point 112 can instruct all electronic devices 110 when to start and stop transmitting. Note that access point 112 and the electronic devices 110 can communicate with one or more legacy electronic devices that are not compatible with the IEEE 802.11 standard (i.e., that do not use multi-user trigger-based channel access).

In some implementations, processing a packet or frame in one of electronic devices 110 access point 112, or a combination of both, includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of electronic devices 110 and access point 112 can communicate with each other. Notably, access point 112 can transmit a PPDU that includes a preamble and a data field. In some implementations, access point 112 can be configured to use concatenated PPDUs (C-PPDUs), e.g., for low latency (LL) communications with receiver stations. A C-PPDU includes a plurality of component PPDUs, each of which can include a preamble and a data payload. As described in more detail below, the C-PPDU includes a plurality of component PPDUs. The first component PPDU is preceded by a first preamble called a “full preamble.” The remaining component PPDUs in the C-PPDU are preceded by respective preambles that are shorter in length than the first preamble. In some implementations, the access point 112 might not perform contention or receive a block acknowledgement (BA) before the plurality of component PPDUs are transmitted.

A network referred to as a basic service set (BSS) is the basic building block of an IEEE 802.11 WLAN. Two stations (STAs) that belong to a BSS are able to communicate directly. An access point (AP) is any entity that has STA functionality and enables access to an architectural component referred to as the distribution system (DS) in the IEEE 802.11 standard. Using an AP, a given STA can communicate with entities outside of a coverage area of a BSS to which the STA belongs. The primary channel is a common channel of operation for all STAs that are members of the BSS. The primary channel of a BSS may also be referred to as a bandwidth. For example, a BSS can use a 20 MHz bandwidth, 40 MHz bandwidth, or another bandwidth.

Furthermore, a STA can buffer data before transmission. This data is typically referred to as traffic. In general, there can be more than one kind of traffic, and therefore, more than one buffer in a STA. The buffers can be physical, virtual, or a combination thereof. Additionally, there may be different urgencies or delay-tolerances (which are sometimes referred to in general as quality of service (QOS)) associated with different buffers. Prompt establishment of channel access is desirable for many traffic types.

An amendment to IEEE 802.11 known as IEEE 802.11ac provides for multi-user multiple input, multiple output (MU-MIMO) techniques. In the MU-MIMO of IEEE 802.11ac, an AP or STA with more than one antenna transmits a PPDU to multiple receiving STAs over the same radio frequencies and each receiving STA simultaneously receives one or more space-time streams. IEEE 802.11ac includes primary channel bandwidths of 20 MHz, 40 MHz, and 80 MHz and a secondary 20 MHz channel. The secondary 20 MHz channel may also be referred to as a secondary channel. The primary channel and the secondary channel may be used together. Several frequency topologies are possible. IEEE 802.11ac includes definitions of high throughput (HT) PPDUs and very high throughput (VHT) PPDUs.

One PHY in IEEE 802.11 is orthogonal frequency-division multiplexing (OFDM) using subcarriers modulated with various levels of quadrature amplitude modulation (QAM) and binary phase shift keying (BPSK) in some cases. In the IEEE 802.11ax draft specification, a STA may support DL and UL OFDMA. In an MU-MIMO RU, there may be support for up to eight users with up to four space-time streams per user up to a limit.

The IEEE 802.11ax Framework provides for 20 MHZ, 40 MHZ, and 80 MHZ OFDMA tone plans based on resource units (RUsRUs). A tone is an OFDM subcarrier. Each RU can include, for example, 16, 52, 106, 242, 484, or 996 tones, depending on the bandwidth of the OFDMA tone plan and the number of RUs in the plan. A STA transmitting over a 20 MHZ OFDMA tone plan can be referred to as transmitting over a 20 MHz channel. An AP transmitting over a first and a second 20 MHz OFDMA tone plans can be referred to as transmitting over first and second 20 MHz channels. Because OFDMA is a multiple access scheme, an AP transmitting over a 20 MHz channel can be addressing one, two, or more recipient STAs simultaneously over the 20 MHz channel using different RUs. Also, using MU-MIMO, an AP can address two or more STAs using a single RU, for example, at the same time. OFDM and OFDMA concepts are further described in the IEEE 802.11ax draft specification.

RU locations of 20 MHz, 40 MHz, 80 MHz, and beyond PPDU bandwidths are supported by 802.11. The PPDU bandwidth includes multiple RUs and each RU includes multiple tones. A receiving STA may observe only a portion of the RUs within a PPDU bandwidth. For example, a PPDU bandwidth may be 40 MHZ, and a receiving STA may only detect and recover information from RUs within the lower or upper 20 MHz bandwidth of the 40 MHz PPDU bandwidth, in some embodiments. The lower 20 MHz bandwidth may be referred to herein as a channel C1 and the upper 20 MHz bandwidth referred to herein as a channel C2, in some embodiments. The IEEE 802.11ax draft specification discusses PPDUs, bandwidths, RUs, tones and STA receive bandwidths.

A STA may include a station management entity (SME), a MAC layer management entity (MLME) and a physical layer management entity (PLME). Moreover, the layers and devices can communicate with each other with standardized primitives defined at service access points (SAPs). Single units of data and/or control information within a layer are called protocol data units (PDUs). For example, a PDU at the physical layer convergence procedure (PLCP) layer is referred to as a PPDU.

The MAC layer in the IEEE 802.11 standard supports a QoS facility. In particular, the QOS facility may support various priority values. A priority value is referred to as a user priority (UP). For example, a STA may inform an AP of QoS information for a given traffic flow using a QoS control field. The QoS control field may include a traffic identifier (TID) and buffer information about data corresponding to the TID. The terms “traffic identifier” and “TID” are used interchangeably herein. Information flow within a STA between layers may be via SAPs. Moreover, the units that flow across a SAP are called MAC service data units (MSDUs), and a TID is a label that distinguishes MSDUs and is used to support QoS by MAC entities. Furthermore, a TID value may specify a traffic category (TC) or a traffic stream (TS). A TC may indicate a distinct user priority (UP) among MSDUs for delivery over a given link, and a TS may be a set of MSDUs to be delivered subject to QoS parameter values provided to the MAC in a particular traffic specification (TSPEC). More details on the QoS facility of the MAC layer are provided in the IEEE 802.11 standard.

The IEEE 802.11 MAC layer provides access to the wireless medium (wireless medium) via a distributed coordination function (DCF). The main access mechanism of IEEE 802.11 is a DCF known as carrier sense multiple access with collision avoidance (CSMA/CA). To transmit, the STA senses the medium to determine if another STA is currently transmitting. When a first STA is not able to sense the presence of a second STA using CSMA/CA, the second STA is referred to as hidden with respect to the first STA. If the STA sensing the wireless medium finds the wireless medium to be busy, the STA defers attempting to transmit until the end of the current transmission. Prior to attempting to transmit, the STA selects a random backoff interval and decrements a backoff interval counter while the wireless medium is idle. After the backoff interval counter reaches zero, if the wireless medium is still idle, the STA can transmit. In order to further reduce the probability of collision on the wireless medium (for example, transmission collision with a hidden STA), short control frames known as Request to Send (RTS) and Clear to Send (CTS) can be used. These procedures of the IEEE 802.11 standard, including IEEE 802.11ac, may be referred to herein as shared wireless medium protocol rules or as wireless medium protocol rules.

Carrier sense can be performed both through physical and virtual techniques. The physical technique is known as clear channel assessment (CCA) and can include an energy measurement or received signal strength indicator (RSSI) measurement. The physical technique is referred to as sensing. The virtual CS mechanism, based on a state variable or value called the network allocation vector (NAV), is achieved by distributing reservation information announcing the impending use of the wireless medium. The NAV provides a prediction of future traffic on the wireless medium based on duration information that is announced in RTS/CTS frames prior to the actual exchange of data. The duration information is also available in the MAC header of many frames. Demodulating and recovering the data of an observed frame is referred to as receiving. The CS mechanism combines the NAV state and the STA's transmitter status with physical CS (CCA) to determine the busy/idle state of the medium. The NAV may be thought of as a counter which counts down to zero at a given rate. When the counter reaches zero or the NAV is reset, the virtual CS indication is that the channel is idle. When the counter is not zero, the CS indication is that the channel is busy.

A STA may maintain two NAV values. One may be an Intra-BSS NAV and the other a OBSS NAV. When an observing STA obtains a NAV value in a MAC frame, the STA also checks the transmitter address field of the MAC frame. Based on the transmitter address, the observing STA knows whether the transmitting AP or STA is in the BSS with the STA. If the transmitting AP or STA is in the BSS, the observing STA sets the intra-NAV. If the transmitting AP or STA is not in the BSS, the observing STA sets the OB SS NAV. The OBSS NAV can be neglected if so commanded by an AP. There may be additional criteria to set the NAV. For example, the energy level of an observed frame may exceed a threshold for the corresponding duration field to be used in setting the NAV.

The duration field may be set to the transmission time for the pending frame, plus one CTS frame, plus one ACK or BA frame and any applicable interframe spaces (IFSs). In an MU-RTS frame, the duration field may be set to the estimated transmission time for the pending transmission.

The exchange of RTS and CTS frames prior to the actual data frame distributes wireless medium reservation information. The RTS and CTS frames contain a duration field that defines the period of time that the medium is to be reserved to transmit the actual data frame and a returning ACK frame. A STA receiving either the RTS (sent by the originating STA) or the CTS (sent by the destination STA) shall read the medium reservation. Thus, a STA can determine information about an impending use of the wireless medium. Thus, exchange of MU-RTS frames and simultaneous CTS responses prior to actual data frames distributes wireless medium reservation information.

In a CTS frame that is transmitted in response to an MU-RTS frame, the duration field is set to the value obtained from the duration field of the MU-RTS frame that elicited the CTS frame minus the time between the end of the PPDU carrying the MU-RTS frame the end of the PPDU carrying the CTS frame.

The MU-RTS frames are transmitted as non-HT Duplicate PPDUs. This means that the frames are copies of each other. The MU-RTS frame will be addressed to the same address in all channels or bandwidths. There are instructions per responding STA; in some embodiments, the responding STAs may only receive the MU-RTS transmitted on their primary channel. The energy of a CTS frame in a secondary channel or bandwidth may be detected by a STA. The duration of the energy, or span in time, corresponds to the duration of the CTS frame.

The MAC layer in a STA can construct MAC frames. A MAC frame may include a MAC header, a variable length frame body, and a cyclic-redundancy check field called the FCS. The MAC header may include an instance of the duration field mentioned above, and address information. The MAC header can also include QoS control information and high throughput (HT) control fields. The QoS control information, if present, may be in a subfield known as the QoS Control field. The QoS control field can also include information related to the data buffer associated with the TID, such as a transmission opportunity (TXOP) duration requested value or a queue size value. The IEEE 802.11 specification supports variations of the HT Control field, which including an high efficiency (HE) and HE A Control field.

An RTS frame is a type of MAC frame and can include, along with a duration field, RA and TA address fields. The RA field of the RTS frame is the address of the STA, accessible via the wireless medium, that is the intended immediate recipient of the pending individually addressed message (data or other frame). The expressions “frame” and “message” are used interchangeably herein. The TA field is the address of the STA transmitting the RTS frame. The duration value indicated in the duration field can be the transmission time for the pending data frame, plus one CTS frame, plus one ACK frame plus three short interframe space (SIFS) intervals.

The CTS frame includes an instance of the duration field and an RA field. The RA field of the CTS frame is copied from the TA field of the immediately previous RTS frame to which the CTS frame is a response. The duration value placed in the CTS frame duration field is obtained by taking the value from the duration field of the immediately previous RTS frame and subtracting the transmission time of the CTS frame and an SIFS interval. More details of RTS-CTS technique can be found in the IEEE 802.11 standard.

Enhanced distributed channel access (EDCA) is a prioritized carrier sense multiple access/collision avoidance (CSMA/CA) scheme used by STAs and APs supporting QoS. A transmission opportunity (TXOP) in EDCA is defined by rules that permit access to the wireless medium based on prioritizing certain access category queues. There is typically a delay, or latency, between initiation of EDCA by a STA to send data and successful transmission of that data because the wireless medium is an unscheduled shared medium prone to collisions when accessed via EDCA. Long delays are unacceptable for many types of traffic. The multi-user (MU) mode EDCA is an extension of the EDCA to support prioritized QoS for high efficiency stations (HE STAs).

The EDCA is able to distinguish between priorities of different service applications, can guarantee a channel access capability of a high-priority service, and can guarantee bandwidth of the high-priority service to some extent.

EDCA supports four access categories (ACs), including background traffic (AC_BK), best effort traffic (AC_BE), video traffic (AC_VI), and, and voice traffic (AC_VO). Different EDCA parameters may be configured, so that a high-priority AC has more sending opportunities and less waiting time. In the protocol, an Access Category Index (ACI) is used to identify the foregoing AC. A queue is selected according to a priority carried in a data frame, so as to ensure QoS in a wireless local area network environment. EDCA supports eight (8) priority levels (priority tags) per STA mapped to the four ACs. In some implementations, voice traffic is highest priority, followed by video traffic, best effort traffic, and background traffic being the lowest priority.

The AP or a STA can configure EDCA parameters. EDCA parameters can include any of arbitration inter-frame spacing (AIFSN), the maximum and minimum contention window size (CW-max, CW-min), TXOP & TXOP Limit, and others.

Arbitration Inter-Frame Spacing (AIFS) defines different inter-frame gaps for traffic from each of the four AC priority queues. AIFS is a technique by the MAC layer to prevent collisions. Interframe spacing is inserted before transmissions for avoiding collisions, and AISF is an interframe spacing technique that uses the AC prioritization to configure the interframe spacing.

CW-min and CW-max indicate the contention window timing. CW-min is used by the algorithm that determines the initial random wait time for data transmission during a period of contention for AP resources. CW-min is the lower limit from which the initial random backoff wait time will be determined. The first random number generated will be a number between 0 and CW-min. If the timer expires before the data frame is sent, a retry counter is incremented and the random backoff value is doubled. Doubling will continue until the size of the random backoff value reaches the number defined in the Maximum Contention Window CW-max. CW-max is the upper limit (e.g., in milliseconds, ms) for the doubling of the random backoff value. This doubling continues until either the data frame is sent or the CW-max size is reached. Once the CW-max size is reached, retries will continue until a maximum number of retries allowed is reached.

The TXOP Limit is a STA EDCA parameter and only applies to traffic flowing from the client STA to the AP. The TXOP is an interval of time, in milliseconds, when a client has the right to initiate transmissions. The TXOP limit is an upper bound on the interval of time for the STA to initiate a transmission.

The IEEE 802.11 standard also provides a collection of features called services. Two example services that can be provided by an IEEE 802.11 WLAN are MSDU delivery and QoS traffic scheduling. QoS traffic scheduling can be contention-based or by controlled channel access. At each TXOP, an IEEE 802.11 STA may select a frame for transmission based on a requested UP and/or parameter values in a TSPEC for an MSDU.

The QoS control field can be sent by a STA to an AP to indicate buffered traffic associated with a given TID awaiting transmission. The receiving AP can use the received QoS control field to schedule controlled channel access, i.e., an uplink transmission opportunity for the STA to send a portion of the data associated with the TID indicated in the QoS control field received by the AP.

According to the IEEE 802.11ax Framework, resource allocation information for one or more addressed STAs can be sent by an AP in a control frame called a trigger frame. The trigger frame may convey or carry sufficient information to identify the STAs transmitting uplink (UL) multiuser (MU) PPDUs and the trigger frame may allocate resources for the addressed STAs to transmit those UL MU PPDUs at a certain time interval subsequent to the trigger frame. The transmissions from all of the STAs contributing to the UL MU PPDU may end at a time indicated in the trigger frame.

The trigger frame is used to allocate resources for UL MU transmission and to solicit UL MU transmissions subsequent to the trigger frame. An MU-RTS frame may request that a STA respond with a CTS frame. An RU allocation subfield in a per-user information field addressed to the STA may indicate whether the CTS frame is to be transmitted on the primary 20 MHz channel, or another channel. A STA addressed by an MU-RTS frame may transmit a CTS response after the end of the PPDU containing the MU-RTS frame if the MU-RTS frame has a per-user information field addressing the STA and if the medium is idle according to CS mechanisms.

An AP can poll STAs to determine the buffer status of respective STAs. Based on the results of the poll, the AP can schedule resources for one or more of the STAs. A given STA can respond with a QoS data frame or with a QoS null data frame. The scheduled STAs then transmit data from their buffers using the scheduled resources. Having accurate buffer status reports at the AP is important to permit the STAs to transmit data from their buffers in a timely manner.

Uplink (UL) orthogonal frequency division multiple access (OFDMA) can be used to support MU EDCA operation. MU-EDCA is supported under UL OFDMA-mandatory mode in 802.11ax (also referred to as Wi-Fi 6). MU-EDCA is a deferred EDCA-based channel contention mechanism for UL OFDMA. For example, assuming a first STA receives a trigger frame to send a high-priority PPDU, after completing the transmission cycle, the first STA enters into a deferred or contentions-based access process. This channel contention using MU-EDCA might be a constraint for low latency (LL) applications. A limiting factor for the first STA is the MU-EDCA timer. This timer is used to provide other STAs (e.g., legacy STAs) an opportunity to transmit, in view of the priority given to the first STA. Typical timer values for the first STA, however, can be relatively large (e.g., approaching or even exceeding 200 millisecond). So after the first STA gets priority transmission, the first STA has to defer to other STAs by this timer period. These are metrics of MU-EDCA-based channel contention advertised in MU-EDCA Parameter Set element carried in a beacon frame. [[Repeating para. numbers]] MU-EDCA was designed, at least in part, to ensure fairness for STAs contending for transmission opportunities, including legacy STAs. After receiving a trigger frame and transmitting high priority (HP) data, the STA enters into a deferred contention period to allow other STAs to contend for resources. This deferred contention period can become problematic for STAs that receive high-priority data for transmissions during the deferred contention period. The deferred contention period can be very long for most (e.g., more than 95%) of the STAs being serviced by an AP.

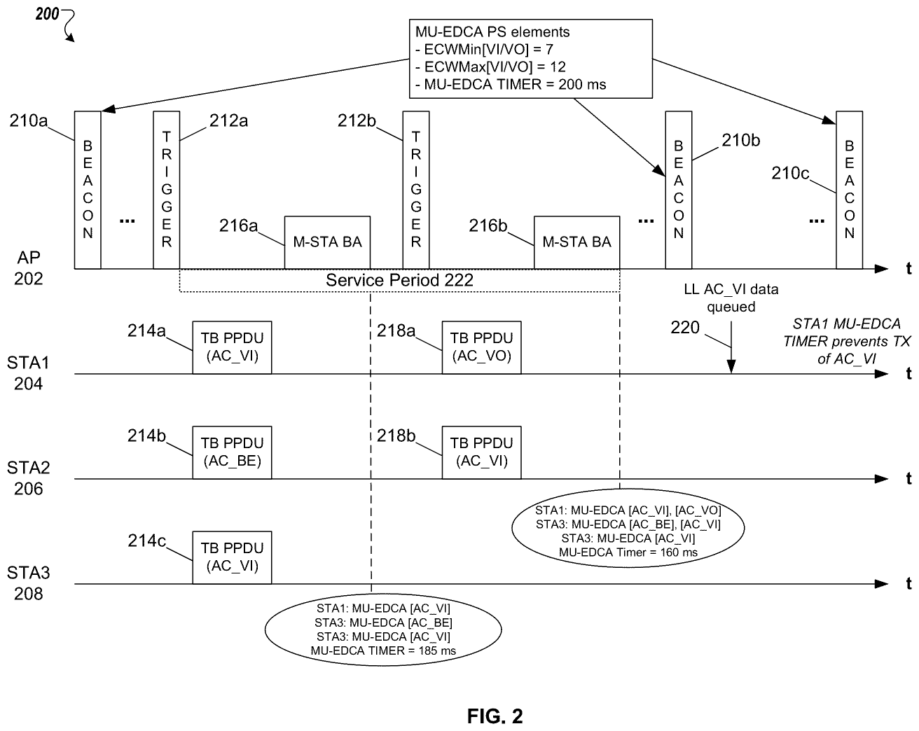

FIG. 2 is a schematic diagram 200 showing an AP servicing multiple STAs operating in MU-EDCA. In FIG. 2, an AP 202 can establish a wireless local area network (WLAN) in an area. The AP 202 can be similar to AP 112 described above. In this example, three stations STA1 204, STA2 206, and STA3 208 are in wireless communication with AP112. The stations STA1 204, STA2 206, and STA3 208 can be similar to the wireless stations 110 described above. Also in this example, the three stations STA1 204, STA2 206, and STA3 208 may be operating under MU-EDCA.

In this example, the AP 202 can transmit beacon frame 210 to one or more of STA1 204, STA2 206, and STA3 208. The beacon 210a can be used to establish the wireless link between the AP 202 and the stations STA1 204, STA2 206, and STA3 208. The beacon 210a can also be used for communicating wireless connection information, such as information about the network, SSID, compatibility information, etc. The beacon frame 210a (as well as other beacon frames 210b and 210c) can communicate MU-EDCA parameters set by the AP. In this example, the beacon frames 210a-210c communicate MU-EDCA parameters as shown in Table 1:

TABLE 1
Example MU-EDCA Parameter Set (PS) Elements

| | |
|---|---|
| ECW-Min [VI/VO] | 7 |
| ECW-Max [VI/VO] | 12 |
| MU-EDCA Timer | 200 ms |

At a later time (represented by the ellipsis in FIG. 2), the STA1 204, STA2 206, and STA3 208 may have traffic (e.g., LL traffic or HP traffic) to send on the OFDMA uplink. The stations can contend for and receive channel access to transmit the traffic. The STA contends using MU-EDCA metrics, as in Table 1 for example, and when the back-off counter decrements to 0, the STA switches to baseline EDCA mode for channel access. When the back-off reaches 0, the STA can transmit the traffic (instead of requesting for transmission resources). The AP 202 can send a trigger frame 212a to each of STA1 204, STA2 206, and STA3 208. The trigger frame 212a is used to allocate uplink resources to one or more stations for transmitting uplink data. The trigger frame can also define a service period 222, though the service period 222 can also be scheduled. The trigger frame 212a can be broadcast to STA1 204, STA2 206, and STA3 208, and can include user identification fields with subfields to identify resource units and other resource allocation for an upcoming OFDMA uplink transmission.

After the stations STA1 204, STA2 206, and STA3 208 receive the trigger frame 212a, the stations can transmit their traffic using uplink resources identified in the trigger frame. For example, STA1 204 can transmit trigger-based (TB) PPDU 214a containing data for a video access category (AC_VI). STA2 206 can transmit TB PPDU 214b containing data for a best effort access category (AC_BE). STA3 208 can transmit TB PPDU 214c containing data for a video access category (AC_VI).

As shown in this example, after the stations STA1 204, STA2 206, and STA3 208 transmit their respective uplink data (under MU-EDCA), the AP 202 can send a multi-station block acknowledgement (M-STA BA or M-STA Block ACK) 216a, which the AP 202 uses to acknowledge receipt of the uplink traffic from the stations. The AP 202 can begin the MU-EDCA timer, the timing of which is set at 200 ms. Here, the MU-EDCA timer is 185 ms. This means that STA1 204, STA2 206, and STA3 208 defer uplink resource contentions using MU-EDCA metrics for a duration indicated by the TIMER value of 185 ms to provide legacy stations (e.g., stations that cannot operate using MU-EDCA) an opportunity to contend for and receive uplink resources. The AP 202 can then send. Table 2 shows this example first uplink transmission, and resulting MU-EDCA timer:

TABLE 2
MU-EDCA Transmissions and Timer

| | MU-EDCA Uplink AC |
|---|---|
| STA1 | AC_VI |
| STA2 | AC_BE |
| STA3 | AC_VI |
| MU-EDCA Timer | 185 ms |

At a later time within the service period 222, the AP 202 can send another trigger frame 212b, which includes resource allocation for the stations STA1 204, STA2 206, and STA3 208 to transmit uplink traffic. In this example, STA1 204 has uplink traffic TB PPDU 218a with voice access category data (AC_VO), which the STA1 204 transmits using resources allocated by the trigger frame 212b. STA2 206 has uplink traffic TB PPDU 218b with video access category data (AC_VI), which STA2 206 transmits using resources allocated by the trigger frame 212b. After the AP receives the uplink traffic from the stations, the AP 202 sends another M-STA BA acknowledging receipt of the MU-EDCA uplink traffic. The M-STA BA can also start the MU-EDCA timer for STA1 204 and STA2 206:

TABLE 3
MU-EDCA Transmissions and Timer

| | MU-EDCA Uplink AC |
|---|---|
| STA1 | AC_VO, AV_VI |
| STA2 | AC_VI, AC_BE |
| STA3 | AC_VI |
| MU-EDCA Timer | 165 ms |

Table 3 shows that the MU-EDCA timer now set for 165 ms. During this deferral period, however, the AP 202 can transmit another beacon frame 210b. The STA1 204 can determine that there is low latency video traffic AC_VI 220a to send on the OFDMA uplink. The STA1 204 cannot transmit this low latency traffic, however, because the STA1 cannot receive uplink resources until after the MU-EDCA timer has expired, which could be over a hundred milliseconds. This can be particularly problematic when the MU-EDCA timer parameter is high (e.g., tens of milliseconds, more than a hundred milliseconds, more than several hundred milliseconds, etc.).

This disclosure describes techniques for, among other things, overcoming the issues described above. In some implementations, each station can exclude one or more access categories of uplink data from being affected by MU-EDCA deferred contention rules. In this first embodiment, each station can avoid specific access categories from operating under MU-EDCA. An Ultra-High Reliability (UHR) Operational Mode (OM) Control subfield is proposed to define rules of UL MU operation suspension for specific ACs.

A station can switch between multi-user operating mode and single user operating mode. A Control Information subfield in Operating Mode (OM) Control subfield is represented by Table 4:

TABLE 4
Control Information Subfield Format in OM Control Frame

| | | | | | B10 | |
|---|---|---|---|---|---|---|
| | B3-B4 | B5 | B6-B8 | B9 | DL MU-MIMO | B11 |
| B0-B2 | Channel | UL MU | Tx | ER SU | Resound | UL MU Data |
| Rx NSS | Width | Disable | NSTS | Disable | Recommendation | Disable |
| 3 bits | 2 bits | 1 bits | 3 bits | 1 bits | 1 bits | 1 bits |

The first row of Table 4 shows the bit mapping, the second row shows the information carried by the subfields, and the third row indicates the number of bits for the field. The Control Information subfield format in OM Control subfield is of 12 bits, total. Uplink multi-user (UL MU) operation is allowed based on values in bits B5 (UL MU Disable) and B11 (UL MU Data Disable). For example, B5=1 and B11=0 signals a mode in which UL MU transmissions are suspended (e.g., for all access categories). A Transmit Operating Mode (TOM) indication allows an operating mode indication (OMI) initiator to suspend or resume responding to variants of a trigger frame.

The TOM indication is STA-specific and not specific to traffic types. For example, TOM indication information currently prohibits a STA the flexibility to select (or exclude) a subset of access categories to follow operation based on B5 and/or B11 subfields. In addition, other traffic identifiers (TIDs) follow baseline UL MU operation. This results in low latency traffic being queued for data within any access category that follows the operating mode set by B5 and B11 subfields of the Control Information subfield in Operating Mode (OM) Control subfield. Operating within the UL MU operating mode (e.g., MU-EDCA) means that queued data can remain queued until the expiry of the MU-EDCA Timer. Table 5 illustrates the UL MU Disable and UL MU Data Disable subfields encoding:

TABLE 5
UL MU Disable and UL MU Data Disable Subfields Encoding

| | | Interpretation by an AP | Interpretation by an AP |
|---|---|---|---|
| | | that transmits a value | that transmits a value |
| | UL MU | of 0 in the OM | of 1 in the OM |
| UL MU | Data | Control UL MU | Control UL MU |
| disable | Disable | Data Disable RX | Data Disable RX |
| subfield | Subfield | Support | Support |
| 0 | 0 | All trigger based UL | All trigger based UL MU |
| | | MU transmissions are | transmissions are |
| | | enabled by the | enabled by the |
| | | STA as defined in | STA as defined in |
| | | 26.5.2 (UL MU | 26.5.2 (UL MU |
| | | operation) | operation) |
| 0 | 1 | N/A | Trigger based UL |
| | | | MU Data frame |
| | | | transmissions in |
| | | | response to a Basic |
| | | | Trigger frame are |
| | | | suspended by the |
| | | | STA as defined in |
| | | | 26.9.3 (Transmit |
| | | | operating mode |
| | | | (TOM) indication). |
| | | | Other trigger based |
| | | | UL MU transmissions |
| | | | remain enabled by the |
| | | | STA as defined in |
| | | | 26.9.3 (Transmit |
| | | | operating mode |
| | | | (TOM) indication). |
| 1 | 0 | All trigger based UL | All tri All trigger based |
| | | MU transmissions are | UL MU transmissions |
| | | suspended by the | are suspended by the |
| | | STA. | STA. |
| | | The STA will | The STA will |
| | | not respond to a | not respond to a |
| | | received triggering | received triggering frame. |
| | | frame. | |
| 1 | 1 | Reserved | Reserved |

This disclosure describes using an Ultra-High Reliability (UHR) Operating Mode (OM) control subfield that can be appended to the OM Control subfield in a transmit operating mode indicator of a MAC layer control signal that indicates additional information for OM Control Subfield.

In some examples, B0-B3 may be used as a bitmap corresponding to 4 ACs in order (e.g., increasing order of priority, but other orders can be used) using B5=1 and B11=0. Table 6 illustrates an OM Control subfield with UHR OM control subfields for AC information:

TABLE 6
Control Information Subfield Format in UHR OM
Control Subfield for ACs

| AC_BK | AC_BE | AC_VI | AC_VO | Reserved |
|---|---|---|---|---|
| B0 | B1 | B2 | B3 | B4-B5 |

The UHR OM Control subfields for ACs includes 6 bits. B0 is mapped to AC_BK, B1 is mapped to AC_BE, B2 is mapped to AC_BK, and B3 is mapped to AC_BK; B4 and B5 are reserved. Other bit mappings are possible and within the scope of this disclosure. The resulting frame structure is illustrated by Table 7:

TABLE 7
OM Control frame with UHR OM Control Information Subfield

| | | | | | B10 | B11 | |
|---|---|---|---|---|---|---|---|
| | B3-B4 | B5 | B6-B8 | B9 | DL MU-MIMO | UL MU | B0-B5 |
| B0-B2 | Channel | UL MU | Tx | ER SU | Resound | Data | UHR OM |
| Rx NSS | Width | Disable | NSTS | Disable | Recommendation | Disable | Control |
| 3 bits | 2 bits | 1 bits | 3 bits | 1 bits | 1 bits | 1 bits | 6 bits |

Table 7 includes 6 bits for the UHR OM Control for ACs. Table 8 shows one possible interpretation of the bit values when using B5 and B11 OM control subfields and UHR OM Control:

TABLE 8
UHR OM Control Interpretation

| UHR | B0-B3 in | B5 | B11 | |
|---|---|---|---|---|
| OM | Control | in | in | |
| Control | Info in | OM | OM | |
| Subfield | UHR | Con- | Con- | |
| Value | OM | trol | trol | Interpretation |
| B0 = 1 | 1000 | 1 | 0 | Trigger-based UL MU Tx for |
| | | | | AC_BK are suspended by STA; UL |
| | | | | MU operation allowed for other ACs |
| B1 = 1 | 0100 | 1 | 0 | Trigger-based UL MU Tx for |
| | | | | AC_BE are suspended by STA; UL |
| | | | | MU operation allowed for other ACs |
| B2 = 1 | 0010 | 1 | 0 | Trigger-based UL MU Tx for AC_VI |
| | | | | are suspended by STA; UL MU |
| | | | | operation allowed for other ACs |
| B3 = 1 | 0001 | 1 | 0 | Trigger-based UL MU Tx for |
| | | | | AC_VO are suspended by STA; UL |
| | | | | MU operation allowed for other ACs |

As shown in Table 8, when B0=1 and B5=1, trigger-based UL MU transmissions for AC_BK data are suspended. UL MU operation is allowed for other ACs. When B1=1 and B5=1, trigger-based UL MU transmissions for AC_BE data are suspended. UL MU operation is allowed for other ACs. When B2=1 and B5=1, trigger-based UL MU transmissions for AC_VI data are suspended. UL MU operation is allowed for other ACs. When B3=1 and B5=1, trigger-based UL MU transmissions for AC_VO data are suspended. UL MU operation is allowed for other ACs.

In another example, B5 is set to 0 and B11 is set to 1. This example is shown in Table 9:

TABLE 9
UHR OM Control Interpretation

| UHR | B0-B3 in | B5 | B11 | |
|---|---|---|---|---|
| OM | Control | in | in | |
| Control | Info in | OM | OM | |
| Subfield | UHR | Con- | Con- | |
| Value | OM | trol | trol | Interpretation |
| B0 = 1 | 1000 | 0 | 1 | Basic trigger-based UL MU Tx for |
| | | | | AC_BK is suspended by STA; UL |
| | | | | MU operation allowed for other ACs |
| B1 = 1 | 0100 | 0 | 1 | Basic trigger-based UL MU Tx for |
| | | | | AC_BE is suspended by STA; UL |
| | | | | MU operation allowed for other ACs |
| B2 = 1 | 0010 | 0 | 1 | Basic trigger-based UL MU Tx for |
| | | | | AC_VI is suspended by STA; UL |
| | | | | MU operation allowed for other ACs |
| B3 = 1 | 0001 | 0 | 1 | Basic trigger-based UL MU Tx for |
| | | | | AC_VO is suspended by STA; UL |
| | | | | MU operation allowed for other ACs |

As shown in Table 9, when B0=1 and B11=1, basic trigger-based UL MU transmissions for AC_BK data are suspended. UL MU operation is allowed for other ACs. When B1=1 and B11=1, basic trigger-based UL MU transmissions for AC_BE data are suspended. UL MU operation is allowed for other ACs. When B2=1 and B11=1, basic trigger-based UL MU transmissions for AC_VI data are suspended. UL MU operation is allowed for other ACs. When B3=1 and B11=1, basic trigger-based UL MU transmissions for AC_VO data are suspended. UL MU operation is allowed for other ACs.

Combinations of high bits for the UHR OM bits is permitted. That is, UHR OM B0-B3 can equal 1 in any combination. If all UHR OM B0-B3 equal 1, then UL MU is suspended for all of the ACs. If all UHR OM B0-B3 are equal to 0, then UL MU is essentially operational for all ACs. As an example, UHR OM B0 and B2 are equal to 1, the UL MU is suspended for AC_BK and AC_VI UL data.

In some implementations, B0-B7 can be defined as a bitmap corresponding to 8 TIDs in order (e.g., increasing order of priority but other orders can be used) using B5=1 and B11=0. Table 10 illustrates an OM Control subfield with UHR OM control subfields for TID information:

TABLE 10
Control Information Subfield Format in UHR OM
Control Subfield for TIDs

| | | | | |
|---|---|---|---|---|
| TID 0 | TID 1 | TID 2 | . . . | TID 7 |
| B0 | B1 | B2 | . . . | B7 |

The UHR OM Control subfields for TIDs includes 8 bits. The B0 is mapped to TID 0, B1 is mapped to TID 1, B2 is mapped to TID 2, etc. till B7, being mapped to TID 7. Other bit mappings are possible and within the scope of this disclosure. The resulting frame structure is illustrated by Table 11:

TABLE 11
OM Control frame with UHR OM Control Information Subfield

| | | | | | B10 | B11 | |
|---|---|---|---|---|---|---|---|
| | B3-B4 | B5 | B6-B8 | B9 | DL MU-MIMO | UL MU | B0-B7 |
| B0-B2 | Channel | UL MU | Tx | ER SU | Resound | Data | UHR OM |
| Rx NSS | Width | Disable | NSTS | Disable | Recommendation | Disable | Control |
| 3 bits | 2 bits | 1 bits | 3 bits | 1 bits | 1 bits | 1 bits | 8 bits |

Table 11 includes 8 bits for the UHR OM Control for TID. Table 12 shows one possible interpretation of the bit values when using B5 and B11 OM control subfields and UHR OM Control:

TABLE 12
UHR OM Control Interpretation

| | B0-B7 | | | |
|---|---|---|---|---|
| UHR | in | B5 | B11 | |
| OM | Control | in | in | |
| Control | Info in | OM | OM | |
| Subfield | UHR | Con- | Con- | |
| Value | OM | trol | trol | Interpretation |
| B0 = 1 | 10000000 | 1 | 0 | Trigger-based UL MU Tx for TID 0 |
| | | | | is suspended by STA; UL MU |
| | | | | operation allowed for other TIDs |
| B1 = 1 | 01000000 | 1 | 0 | Trigger-based UL MU Tx for TID 1 |
| | | | | is suspended by STA; UL MU |
| | | | | operation allowed for other TIDs |
| B2 = 1 | 00100000 | 1 | 0 | Trigger-based UL MU Tx for TID 2 |
| | | | | is suspended by STA; UL MU |
| | | | | operation allowed for other TIDs |
| B3 = 1 | 00010000 | 1 | 0 | Trigger-based UL MU Tx for TID 3 |
| | | | | is suspended by STA; UL MU |
| | | | | operation allowed for other TIDs |
| B4 = 1 | 00001000 | 1 | 0 | Trigger-based UL MU Tx for TID 4 |
| | | | | is suspended by STA; UL MU |
| | | | | operation allowed for other TIDs |
| B5 = 1 | 00000100 | 1 | 0 | Trigger-based UL MU Tx for TID 5 |
| | | | | is suspended by STA; UL MU |
| | | | | operation allowed for other TIDs |
| B6 = 1 | 00000010 | 1 | 0 | Trigger-based UL MU Tx for TID 6 |
| | | | | is suspended by STA; UL MU |
| | | | | operation allowed for other TIDs |
| B7 = 1 | 00000001 | 1 | 0 | Trigger-based UL MU Tx for TID 7 |
| | | | | is suspended by STA; UL MU |
| | | | | operation allowed for other TIDs |

As shown in Table 12, when B0=1 and B5=1, trigger-based UL MU transmissions for TID 0 data are suspended. UL MU operation is allowed for other ACs. When B1=1 and B5=1, trigger-based UL MU transmissions for TID 1 data are suspended. UL MU operation is allowed for other ACs. When B2=1 and B5=1, trigger-based UL MU transmissions for TID 2 data are suspended. UL MU operation is allowed for other ACs. When B3=1 and B5=1, trigger-based UL MU transmissions for TID 3 data are suspended. UL MU operation is allowed for other ACs. When B4=1 and B5=1, trigger-based UL MU transmissions for TID 4 data are suspended. UL MU operation is allowed for other ACs. When B5=1 and B5=1, trigger-based UL MU transmissions for TID 5 data are suspended. UL MU operation is allowed for other ACs. When B6=1 and B5=1, trigger-based UL MU transmissions for TID 6 data are suspended. UL MU operation is allowed for other ACs. When B7=1 and B5=1, trigger-based UL MU transmissions for TID 7 data are suspended. UL MU operation is allowed for other ACs.

In some embodiments, B5=0 and B11=1. The resulting interpretation is shown in Table 13:

TABLE 13
UHR OM Control Interpretation

| UHR | B0-B7 in | B5 | B11 | |
|---|---|---|---|---|
| OM | Control | in | in | |
| Control | Info in | OM | OM | |
| Subfield | UHR | Con- | Con- | |
| Value | OM | trol | trol | Interpretation |
| B0 = 1 | 10000000 | 0 | 1 | Basic Trigger-based UL MU Tx for |
| | | | | TID 0 is suspended by STA; UL MU |
| | | | | operation allowed for other TIDs |
| B1 = 1 | 01000000 | 0 | 1 | Basic Trigger-based UL MU Tx for |
| | | | | TID 1 is suspended by STA; UL MU |
| | | | | operation allowed for other TIDs |
| B2 = 1 | 00010000 | 0 | 1 | Basic Trigger-based UL MU Tx for |
| | | | | TID 2 is suspended by STA; UL MU |
| | | | | operation allowed for other TIDs |
| B3 = 1 | 00010000 | 0 | 1 | Basic Trigger-based UL MU Tx for |
| | | | | TID 3 is suspended by STA; UL MU |
| | | | | operation allowed for other TIDs |
| B4 = 1 | 00001000 | 0 | 1 | Basic Trigger-based UL MU Tx for |
| | | | | TID 4 is suspended by STA; UL MU |
| | | | | operation allowed for other TIDs |
| B5 = 1 | 00000100 | 0 | 1 | Basic Trigger-based UL MU Tx for |
| | | | | TID 5 is suspended by STA; UL MU |
| | | | | operation allowed for other TIDs |
| B6 = 1 | 00000010 | 0 | 1 | Basic Trigger-based UL MU Tx for |
| | | | | TID 6 is suspended by STA; UL MU |
| | | | | operation allowed for other TIDs |
| B7 = 1 | 00000001 | 0 | 1 | Basic Trigger-based UL MU Tx for |
| | | | | TID 7 is suspended by STA; UL MU |
| | | | | operation allowed for other TIDs |

As shown in Table 13, when B0=1 and B11=1, trigger-based UL MU transmissions for TID 0 data are suspended. UL MU operation is allowed for other ACs. When B1=1 and B11=1, trigger-based UL MU transmissions for TID 1 data are suspended. UL MU operation is allowed for other ACs. When B2=1 and B11=1, trigger-based UL MU transmissions for TID 2 data are suspended. UL MU operation is allowed for other ACs. When B3=1 and B11=1, trigger-based UL MU transmissions for TID 3 data are suspended. UL MU operation is allowed for other ACs. When B4=1 and B11=1, trigger-based UL MU transmissions for TID 4 data are suspended. UL MU operation is allowed for other ACs. When B5=1 and B11=1, trigger-based UL MU transmissions for TID 5 data are suspended. UL MU operation is allowed for other ACs. When B6=1 and B11=1, trigger-based UL MU transmissions for TID 6 data are suspended. UL MU operation is allowed for other ACs. When B7=1 and B11=1, trigger-based UL MU transmissions for TID 7 data are suspended. UL MU operation is allowed for other ACs.

Combinations of high bits for the UHR OM bits is permitted. That is, UHR OM B0-B3 can equal 1 in any combination. If all UHR OM B0-B7 equal 1, then UL MU is essentially suspended for all of the TIDs. If all UHR OM B0-B7 are equal to 0, then UL MU is essentially operational for all TIDs. As an example, UHR OM B0 and B2 are equal to 1, the UL MU is suspended for TID 0 and TID 2 UL data.

Two or more bits in UHR OM Control subfield may be set to 0 or 1 by a STA. A trigger frame for more than one AC can be excluded or included (or turned off or on).

Traffic in an AC/TID with corresponding subfield value in UHR OM subfield set to 1 shall follow EDCAF with EDCA parameters advertised in EDCA Parameter Set element, instead of MU-EDCA parameters, when B5=1 in OM Control for Option 1a (AC) or 2a (TID), respectively. Traffic in an AC/TID with corresponding subfield value in UHR OM subfield set to 1 shall follow EDCAF with EDCA parameters advertised in EDCA Parameter Set element, instead of MU-EDCA parameters, when B11=1 in OM Control for Option 1b (AC) or 2b (TID), respectively.

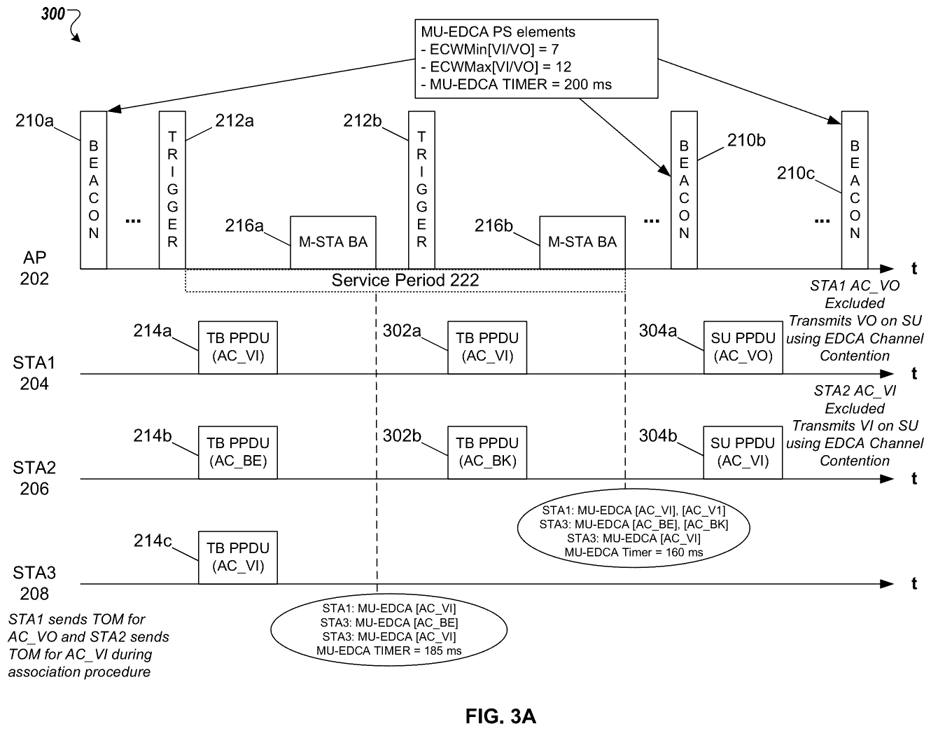

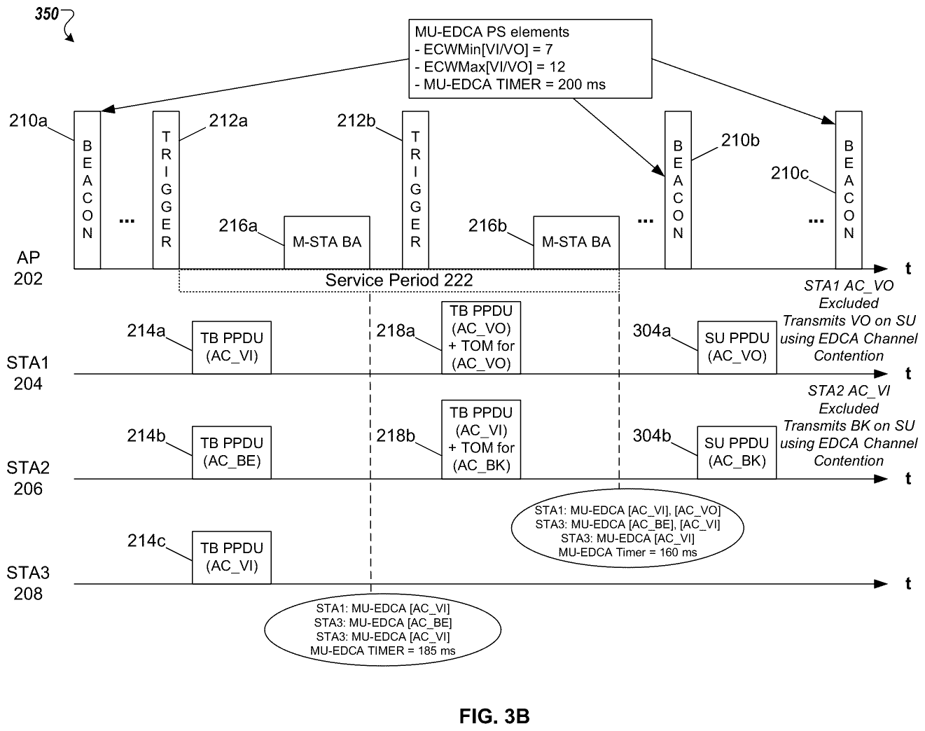

Turning to FIGS. 3A-B, FIG. 3A is a schematic diagram 300 showing a first example of selective MU-EDCA exclusion in accordance with some implementations of the present disclosure. FIG. 3B is a schematic diagram 350 showing a second example of selective MU-EDCA exclusion in accordance with some implementations of the present disclosure. FIGS. 3A-3B are similar to FIG. 2 in that STA1 204, STA2 206, and STA3 208 are operating under MU-EDCA.

In FIG. 3A, a station can inform the AP during an association procedure or other connection procedure, of the one or more ACs or TIDs that the station wants to exclude from MU-EDCA. The AP and the STA can maintain the exclusion information for the duration of the connection or for some other time period. The STA can reset the MU-EDCA exclusions using another TOM signal. In FIG. 3B, a station can inform the AP of an AC or TID exclusion from MU-EDCA using control signaling transmitted with a TB PPDU, e.g., after the station receives a trigger frame indicating that the TF is the last trigger frame within a service period.

In either case, the MAC layer signaling for indicating AC or TID exclusion includes a transmit operation mode (TOM) indicator with an operating mode indicator (OMI) in an operating mode (OM) control subfield. For example, an OM control subfield can contain a UHR OM Control indication using a control information subfield that indicates one or more ACs or TIDs for MU-EDCA exclusion.

In the example of FIG. 3A, STA1 204 can send a TOM indicator with an AC_VO exclusion indication to the AP 202 during an association procedure or other procedure. STA2 206 can likewise send a TOM indicator with an AC_VI exclusion indication to the AP 202 during an association procedure or other procedure. The AP 202 and the STA1 204 and STA2 206 can remember the AC/TID exclusion for later use.

During a service period 222, and as an MU-EDCA timer is running, the stations can receive a trigger frame 212b for sending trigger-based PPDUs. For example, STA1 can transmit TB PPDU (AC_VI) 302a and the STA2 206 can transmit TB PPDU (AC_BK) 302b during the service period. If a station has or receives low latency traffic of an AC or TID type that is excluded, the station can contend for resources to send that low latency traffic using non-multi-user EDCA (so-called baseline EDCA or single user EDCA).

For example, STA1 204 may determine to transmit low latency data of AC_VO after the service period 222. Because the STA1 204 has already excluded AC_VO traffic from MU-EDCA, the STA1 204 can use single user (SU) EDCA to contend for resources and transmit an SU PPDU for AC_VO 304a low latency traffic using the assigned resources.

Likewise, STA2 206 may determine to transmit low latency data of AC_VI after the service period 222. Because the STA2 206 has already excluded AC_VI traffic from MU-EDCA, the STA2 206 can use single user (SU) EDCA to contend for resources and transmit an SU PPDU for AC_VI 304B low latency traffic using the assigned resources.

STA1 and STA2 can maintain the AC/TID exclusion until they send another TOM control signal to the AP to change the excluded AC/TID.

In FIG. 3B, STA1 204 and STA2 206 receive a trigger frame 212b from the AP 202 during a service period 222. In this example, the stations receive a trigger frame 212b while an MU-EDCA timer is running. The stations can determine that they have or will have low latency data for uplink transmissions after the expiration of the service period, and therefore, the stations can exclude the low latency traffic from MU-EDCA.

A station can determine or predict that there will be more data to send after the end of a service period using various techniques. For example, a station can determine that an application is running that may have another low latency (or high priority) data transmission. The station can also determine what access category or traffic type that data will likely be. Other mechanisms are also available for the station to predict what data is to be sent, such as historical data, predefined transmissions, etc.

The stations can prepare the TOM indication, as described above, and include the TOM indication as part of MAC layer control signaling with an outbound TB PPDU that is being transmitted to the AP on resources assigned to the stations by the trigger frame 212b.

For example, STA1 204 in FIG. 3B can receive a trigger frame 212b for transmitting low latency traffic for AC_VO to the AP. The trigger frame can indicate that the TF is the last trigger frame in the service period. STA1 204 can prepare a TB PPDU 218a to transmit the AC_VO low latency traffic to the AP. The STA1 204 can determine that there will be more low latency AC_VO traffic to send after the service period ends. In view of the trigger frame 212b being the last trigger frame in the service period, STA1 204 can also generate a TOM control message with an AC_VO exclusion set for AC_VO data, and transmit the TOM with a TB PPDU 218a to the AP 202. After the service period, the STA1 204 can contend for resources using SU EDCA or baseline EDCA, construct an SU PDU 304a for the AC_VO low latency traffic, and send the SU PPDU 304a with the low latency AC_VO traffic to the AP. As shown in FIG. 3B, in some implementations, an AC or TID can be excluded dynamically and for any AC or TID, independent of the AC/TID of the most recent transmission.

In another example, STA2 206 can also receive the trigger frame 212b for transmitting low latency traffic for AC_VI to the AP. The trigger frame can indicate that the TF is the last trigger frame in the service period. STA2 206 can prepare a TB PPDU 218b to transmit the AC_VI low latency traffic to the AP. The STA2 206 can determine that there is low latency AC_BK traffic to send after the service period ends. In view of the trigger frame 212b being the last trigger frame in the service period, STA2 206 can also generate a TOM control message with an AC_BK exclusion set for AC_BK data, and transmit the TOM with a TB PPDU 218b to the AP 202. After the service period, the STA2 206 can contend for resources using SU EDCA or baseline EDCA, construct an SU PDU 304b for the AC_BK low latency traffic, and send the SU PPDU 304b with the low latency AC_BK traffic to the AP 202.

In the examples shown in FIG. 3B, the exclusions can be reset or changed using another TOM control signal that is transmitted to the AP at another time.

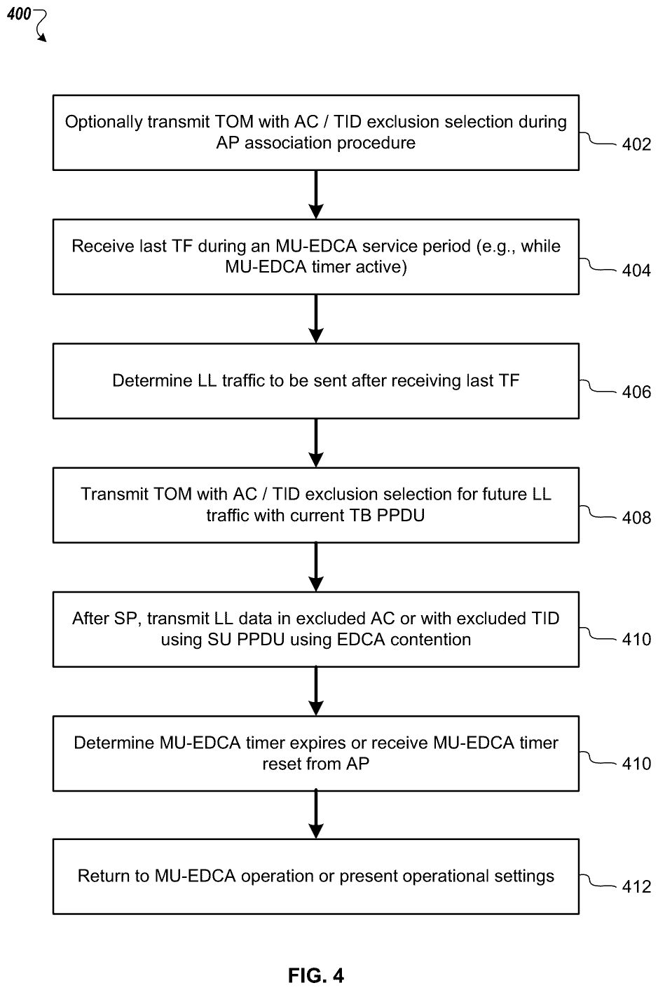

FIG. 4 is a process flow diagram 400 showing an example of transmitting low latency uplink traffic using an MU-EDCA exclusion process in accordance with some implementations of the present disclosure. FIG. 4 illustrates a flowchart of an example method 400, according to some implementations. For clarity of presentation, the description that follows generally describes method 400 in the context of the other figures in this description. For example, method 400 can be performed by a station (STA) of FIGS. 1-3, 5-6, and 8. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At the outset, optionally, the wireless device can transmit a transmit operating mode (TOM) control signal with an ultra-high reliability (UHR) operating mode control field set to exclude one or more access category (AC) or traffic identifier (TID) traffic types from MU-EDCA operation. This is optional because the wireless device can perform this step dynamically during MU-EDCA operation when the wireless device determines the presence or predicts the presence of low latency traffic to be sent during an MU-EDCA deferred contention period.

During MU-EDCA operation, a wireless device (or STA) can determine (404) that it has low latency data to transmit to an access point using the uplink multi-user mode, the low latency data of a type defined by the AC or TID excluded from uplink multi-user mode. This determination can be made during a service period, while an MU-EDCA timer is running. This determination can be made, for example, after the wireless device receives a trigger frame indicating that the TF is the last trigger frame before the expiration of the service period. The determination can be made at some point before the expiration of the MU-EDCA timer (including after the service period ends). When the wireless device has low latency traffic queued, the wireless device can use the queued low latency traffic to identify 1) the presence of the traffic and 2) the access category or traffic identifier associated with the queued traffic. The wireless device can also predict that the wireless device will have low latency traffic in the near future (e.g., within the time period of the MU-EDCA timer). For example, the wireless device can use statistical data, one or more running applications, and/or other information to predict the type of traffic to be sent. An example is if a specific application, such as a streaming video or video conference application is running, the wireless device may predict that low latency traffic of AC_VO type is imminent for uplink transmission.

The wireless device can construct a TB PPDU, e.g., in response to the trigger frame. The TB PPDU will include whatever low latency traffic is to be sent in response to the trigger frame. The wireless device can also generate a TOM with an AC or TID exclusion bit set for one or more low latency traffic types to be sent after the expiration of the service period, as described above. The TOM can be sent with the TB PPDU as a MAC layer control message. The wireless device can set the exclusion bit in an operating mode control subfield of a transmit operating mode indicator frame, the bit indicating the exclusion of one access category (AC) or one traffic identifier (TID) from the uplink multi-user mode, while also setting one of the MU-EDCA disable or MU-EDCA data disable bits. The wireless device can send (408) the TB PPDU to the AP with the TOM indicator frame.

After the expiration of the service period but before the expiration of the MU-EDCA timer, the wireless device can transmit the low latency traffic using an SU PPDU. For example, the wireless device can initiate a single user or baseline EDCA contention process for transmitting the low latency traffic using EDCAF with EDCA parameters. In so doing, the wireless device can request—and be granted—uplink resources from the access point to transmit the low latency data in the excluded AC or excluded TID the access point using a single user enhanced distributed channel access contention mechanism.

The wireless device can determine (410) that the MU-EDCA timer is expired, or the wireless device can receive an MU-EDCA parameter reset from the AP. The wireless device can return (412) to operating under MU-EDCA for all ACs/TIDs by resetting the AC/TID exclusion bit(s). This resetting can occur anytime, including during another MU-EDCA service period.

Upon receiving a TOM with UHR OM indicating an AC or TID exclusion, the AP shall not transmit a trigger frame to this STA requesting UL transmissions from an AC indicated in the UHR OM field.

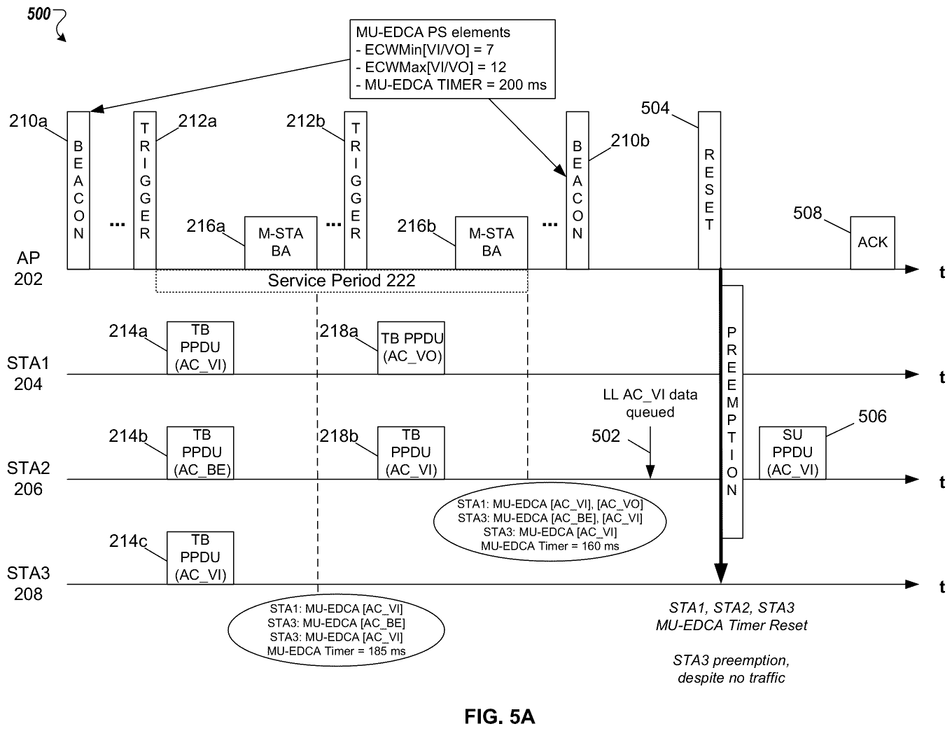

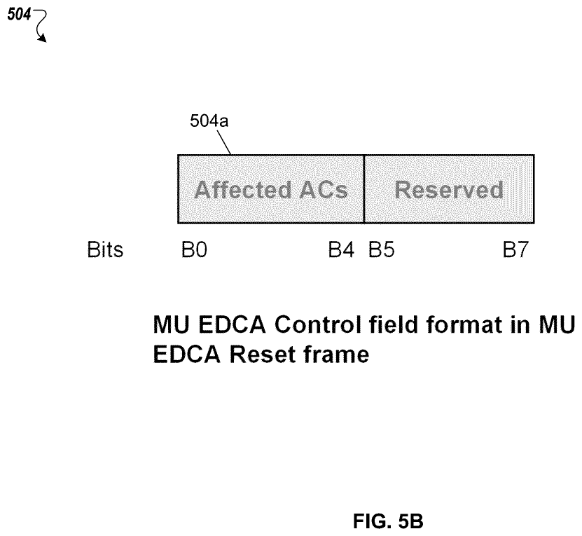

FIG. 5A illustrates an example of AEM. FIG. 5A is a schematic block diagram 500 illustrating an example wirelessly connected system operating under assisted EDCA mode for uplink multi-user operation. In FIG. 5A, after the service period 222 ends, and while the MU-EDCA timer is active, STA2 206 can receive low latency video traffic AC_VI 502, which STA2 queues for transmission, awaiting the reset frame from the AP 202. The AP 202 can transmit an MU-EDCA timer reset frame 504 to stations STA1 204, STA2 206, and STA3 208. Transmission of the reset frame resets the existing value of the MU-EDCA Timer to 0 for STAs that are operating under MU-EDCA. AP 202 can send an MU-EDCA reset frame 504 (e.g., which can be a Protected high efficiency (HE) Action frame or 802.11ax action frame) in broadcast mode that resets the MU-EDCA timer for a specific access category or categories indicated in the frame. Within the reset frame, there is a bitmap indication of AC(s) that can be reset. If all bits in the bitmap are set to 1, the TIMER corresponding to each AC is reset. The MU-EDCA reset frame 504 can be sent either in unicast or broadcast (resets all recipient STAs) mode. Unicast only resets for a single directed STA, while the reset frame in broadcast mode affects all STAs in MU-EDCA mode.

The MU-EDCA reset frame 504 structure is shown in FIG. 5B, which is a diagram illustrating the MU-EDCA control field format in an example MU-EDCA reset frame. The “Affected ACs” subfield 504a indicates a bitmap mapping the bits to access categories to be reset. In one example, the Affected ACs subfield 504a can include a bitmap as follows: B0 mapped to AC_BK, B1 mapped to AC_BE, B2 mapped to AC_VI, and B3 mapped to AC_VO, though other bitmapping is possible and within the scope of this disclosure.

Because STA2 has low latency AC_VI traffic, the STA can invoke an EDCA backoff (B0) procedure for the access categories indicated in Affected ACs subfield 504a. Here, AC_VI is mapped to B3 in the Affected ACs subfield 504a bitmap of the MU-EDCA reset frame 504.

After the stations receive the MU-EDCA timer reset frame 504, STA2 208 can send the low latency traffic as a single user (SU)-PPDU 506 with data for AC_VI. The AP 202 can then send an ACK 508 to the STA2 208.

One issue with the AEM is that the AP 202 broadcasts the MU-EDCA reset frame 504 to all of the stations. Therefore, stations that are within the MU-EDCA deferred contention timer will have their timers reset, even if those stations do not have low latency uplink traffic queued.

The AP collects statistics, including QOS IE, that the AP uses to deduce that the STAs may have low latency traffic. If the STAs are in MU-EDCA mode, the AP can send the reset frame. The reset frame will either go to all of the STAs (broadcast) or go to one STA (unicast). There are considerations for both. For example, the AP may be unable to direct the reset frame to one or more specific STAs with LL UL traffic because the AP is unaware of which STAs have pending LL UL traffic. Also, sending a unicast reset frame is resource intensive and may result in inefficient usage of channel air time. Conversely, broadcasting a reset frame may create fairness issues (e.g., by precluding other STAs from using a TXOP).

In some implementations of the present disclosure, a station can use a low latency presence frame to solicit a trigger frame from the AP, e.g., based on the station having low latency data queued for OFDMA uplink transmission. The AP can transmit an MU-EDCA timer reset permission in an MR-TF frame to the requesting station. The MR-TF can also include a resource allocation for the station to transmit the low latency traffic.

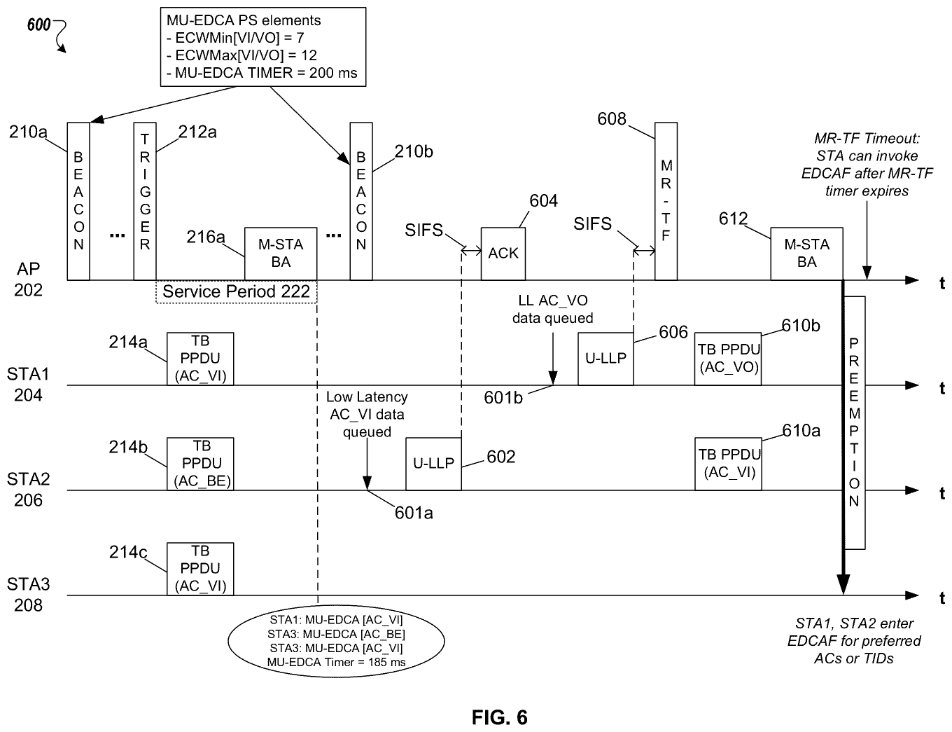

FIG. 6 is a schematic diagram 600 of an example wireless device initiating a solicited trigger mode (STM) with an access point in accordance with some implementations of the present disclosure. In FIG. 6 (like FIG. 5A), the stations (STA1 204, STA2 206, and STA3 208) can be operating in MU-EDCA mode. At the outset, the stations can negotiate one or more preferred ACs or TIDs for solicited trigger mode (STM) operation. STM operation allows a station to solicit a trigger frame (e.g., requesting a TF within a Short Interframe Space (SIFS) time period) during MU-EDCA operation, at least for low latency traffic of one or more preferred ACs or preferred TIDs. The stations can use a stream classification service (SCS) frame exchange to perform the negotiations for identifying the preferred ACs or TIDs.

To initiate STM, a station can send an unsolicited low latency presence (U-LLP) control frame to the AP 202. The U-LLP frame can be interpreted by the AP 202 as a request for a trigger frame. Specifically, the U-LLP can be interpreted as a request for a solicited trigger frame to transmit the low latency traffic of a preferred AC or TID. The U-LLP is essentially a solicitation of a trigger frame, which the station can use during an MU-EDCA deferred contention period to try to send low latency traffic. In some embodiments, the U-LLP is a solicitation of a MU-EDCA Reset Trigger frame (MR-TF). The different types of trigger frames are discussed later.

An example of a U-LLP control frame is shown in Table 14:

TABLE 14
Example U-LLP Control Frame Structure

| Frame Control | Duration | RA | TA | LL Buffer Status | FCS |
|---|---|---|---|---|---|
| 2 Octets | 2 Octets | 6 Octets | 6 Octets | 2 Octets | 4 Octets |

In Table 14, the Frame Control field includes 2 octets of information regarding the distributed system within which the frame is generated. The Duration field indicates the duration of the U-LLP frame, the RA field indicates the receiver address, the TA field indicates the transmitter address, the FCS field indicates the frame check sequence applied on the data for error detection, and the Low latency (LL) Buffer Status indicates the AC that has buffered LL data and the queue size. Table 15 provides an example of the bit fields for the LL Buffer Status of the U-LLP control frame:

TABLE 15
Low latency (LL) Buffer Status Field

| LL AC | Scaling Factor | Queue Size | Reserved |
|---|---|---|---|
| 2 bits | 2 bits | 8 bits | 4 bits |

As shown in Table 15, the LL Buffer Status field may include an LL AC subfield which indicates the AC that has buffered LL data, a Scaling Factor field which indicates (in units of octets) the value in the following Queue Size subfield, the Queue Size subfield which indicates the amount of buffered LL data (in units of octets) for the AC indicated in the LL AC subfield, and four reserved bits which can be defined to indicate the type of frame solicited from the AP. For example, a value of 0 may indicate SMRTF, a value of 1 may indicate SPTF, a value of 2 may indicate Ranging Polling TF, a value of 3 may indicate Sensing Polling TF, and a value of 4 may indicate Solicited Grant.

Multiple Buffer Status fields can be included if the STA intends to buffer LL traffic in multiple AC queues. Generally, the U-LLP bit mapping can be used for indicating (to the AP) that the frame is a U-LLP frame and for indicating the type of control frame requested. In some implementations, the bit mapping can also indicate the amount of LL data buffered at the STA.

The U-LLP frame can be implemented as a MAC frame or as a null data packet (NDP) frame. For a MAC frame, the U-LLP frame can include a MAC header and MAC signaling, in addition to the specific bitfield mapping shown above for U-LLP functionality. This implementation is shown above in Tables 14-15 and the accompanying text.

In some implementations, the U-LLP frame can be implemented as an NDP frame with a UHR and/or a legacy PHY preamble and PHY header and/or synchronization information (e.g., no MAC Header or MAC signaling included), along with the U-LLP-specific bitmapping.

To indicate that a NDP frame is a U-LLP frame, the STA can encode the UHR-SIG field in the PHY preamble using 1 bit special signaling indicating that the NDP frame is a U-LLP frame that solicits a control frame or trigger frame (TF). The SIG field may also contain signaling about the AC/TID value and type of control frame requested/solicited.

The UHR-SIG field in a UHR NDP frame may include an indication of a U-LLP frame, an indication of a type of control frame solicited, an AC/TID, a buffer size corresponding to an AC/TID, or any combination thereof.

The UHR-SIG field in the PHY preamble can carry signaling about specific control frames. In some implementations, the signaling can be identical to the signaling proposed for the Reserved 4 bits carried in the U-LLP MAC frame. In some examples, a value of 0 indicates SMRTF, a value of 1 indicates SPTF, a value of 2 indicates a Ranging Polling TF, a value of 3 indicates a Sensing Polling TF, and a value of 4 indicates a Solicited Grant.

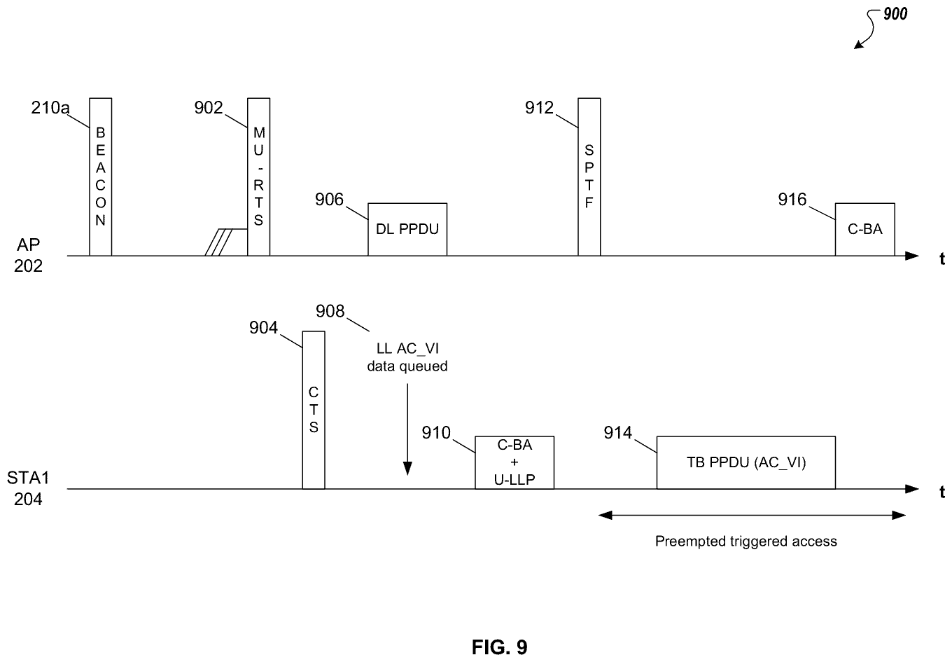

The U-LLP frame can be implemented as a MAC frame or an NDP frame. The U-LLP frame can be used for other purposes, as described in the text accompanying FIGS. 9-13. Generally, the U-LLP frame can be sent by a STA to an AP to request a control frame of a particular type, e.g., so that the STA can perform a function at a time when the STA does not have access to the channel.

In FIG. 6, an MU-EDCA timer has begun because STA1 204, STA2 206, and STA3 208 have all performed MU-EDCA transmissions, as described in FIG. 5A. As shown in FIG. 6, the MU-EDCA timer is set at 185 ms. In other implementations, other values can be used. After the service period 222 has lapsed, but during the MU-EDCA deferred contention period (timer period), STA2 206 can determine that there is low latency AC_VI traffic 601a to send on the uplink, where AC_VI is one of the negotiated preferred ACs for STA2. The STA2 206 sends U-LLP Control frame 602 (e.g., using EDCA), soliciting a trigger frame from the AP 202.

In this example, the AP is unable to schedule the uplink transmission for the STA2 206, so the AP 202 sends the STA2 206 an ACK 604 (e.g., within a SIFS period). The ACK 604 can be transmitted in a solicited trigger frame (e.g., MR-TF) without resource allocation. The U-LLP 602, therefore, can be considered a solicitation of a trigger frame, even if no resource allocation for uplink transmissions are provided by the AP 202 in response to the U-LLP 602. The ack 604 can also alert the STA2 206 that the AP 202 is in receipt of the U-LLP and acknowledges the request for resources, but cannot fulfill the request, and that the STA2 206 should wait. This ACK 604 prevents the STA2 206 from continuing to transmit U-LLP to the AP 202.

In another example in FIG. 6, STA1 204 also determines that there is low latency AC_VO traffic to send, where AC_VO traffic is one of the negotiated preferred ACs for STA1. The STA1 204 sends a U-LLP 606 to the AP 202. In this example, the AP 202 can respond with resource scheduling. The AP 202 sends a solicited trigger frame (e.g., MR-TF) 608 to stations STA1 204 and STA2 206, where the solicited trigger frame includes an acknowledgement of the U-LLP 606 (and possibly also the U-LLP 602), as well as resource allocation for each STA1 204 and STA2 206. STA2 206 can transmit low latency traffic for AC_VO using TB PPDU 610a using resources allocated by the solicited trigger frame 608. STA1 204 can transmit low latency traffic for AC_VO using TB PPDU 610b using resources allocated by the solicited trigger frame 608.

The AP 202 can provide resource allocation (e.g., resource units (RUsRUs)) for STA2 206, after the AP 202 gets the U-LLP frame from STA1 204, assuming STA2 206 has not sent a power management indicator indicating a sleep state or other power management state (e.g., PM=1 or PM=nonzero) between the time STA2 206 sends U-LLP and AP receives U-LLP from STA1 204 and gets ready to send MR-TF 608.

The AP 202 can receive the uplink traffic and respond with a M-STA BA 612. The M-STA BA 612 can include an MU-EDCA reset. Or the AP 202 can send an MU-EDCA reset after the M-STA BA 612. Resetting the MU-EDCA parameters can cause the stations to invoke EDCAF with MU-EDCA. In some embodiments, the solicited trigger frame 608 can being a timer, and the expiration of the timer can allow the stations to invoke EDCAF with MU-EDCA.

Numerical analysis shows that STM significantly improves performance of a STA in MU EDCA mode (see appendix).

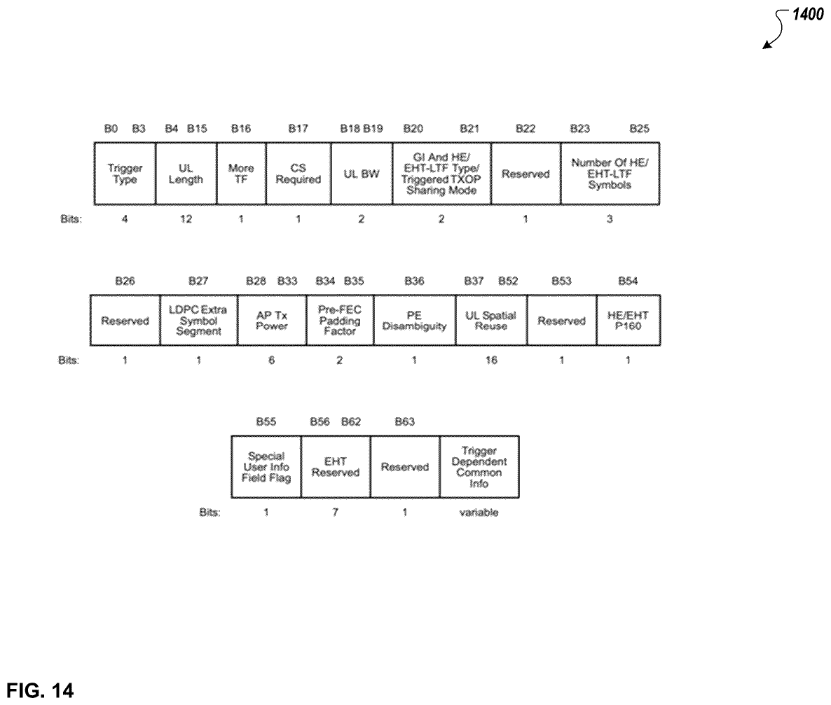

As mentioned before, the U-LLP 602 can be considered to be a solicitation of a trigger frame from the AP 202. The trigger frame can come in various forms. For example, in some implementations, the solicited trigger frame (i.e., MR-TF) can be defined as a new trigger frame format or the trigger frame can reuse the format of a basic trigger frame. FIG. 14 illustrates an example of a basic trigger frame 1400 repurposed for use as an MR-TF.

The basic trigger frame variant depicted in FIG. 14 can be used for solicited trigger frame, including MR-TF. The common info field includes an UL Length field, which can be used to indicate the acknowledgement of the U-LLP and whether resources are to be allocated for UL transmission. For example:

If UL Length=0, AP cannot schedule uplink, but MR-TF is regarded as ACK from AP of receipt of U-LLP (station receiving can stop soliciting trigger frame and wait). IN some implementations, UL Length=0 can indicate rejection of STM.

If UL Length=non-zero, the AP can schedule the uplink, and AP 202 can send resource allocation in other parts of the MR-TF. In some implementations, UL Length=non-zero is an indication of the activation of STM.

In some implementations, the AP 202 can send a solicited MR-TF to reset MU EDCA parameters. The AP 202 can, however, reset MU-EDCA parameters using other techniques, including sending a M-STA BA (e.g., M-STA BA 612) with a solicited MU EDCA Reset Trigger frame to reset MU-EDCA parameters after receiving the low latency traffic on TB PPDU. The MR-TF 608 can also start a reset timer, which when expired, allows the stations to invoke EDCAF with MU-EDCA.

Resetting the MU-EDCA parameters can cause the one or more stations to restart EDACF with MU-EDCA.

Another option is that the AP 202 can send a solicited MU-EDCA reset frame to the stations after sending the M-STA BA 612. Table 17 provides an example M-STA BA structure:

TABLE 17
M-STA BA Structure for Traffic from Solicited Trigger frame

| M-STA BA Subfield | Interpretation |
|---|---|
| Reset = 0 | With MR-TF, STA disallowed to reset MU- |
| | EDCA Timer |
| Reset = 1 | With MR-TF, STA allowed to reset MU- |
| | EDCA timer unless timeout value expires |
| Reset = 0/1 | With Basic TF, this field is ignored and STA |
| | continues with baseline EDCA behavior. |

Definition of UHR variant Common Info field in Basic or newly defined Trigger frame: Backward compatibility with 11be. In one example, B56=0 for UHR Trigger, and B57-B62 as UHR Reserved and value set to 1 to indicate the frame is a MR-TF.

For B0-B3 (Trigger Type), the bit mapping as described in Table 18 can be used:

TABLE 18
Trigger Type of Common Info Field for UHR Variant of Trigger frame

| Trigger Type Subfield Value | Trigger frame Variant |
|---|---|
| 0-8 | Take by 11ax and 11az |
| 9 | Solicited Trigger (this disclosure) |
| 10-15 | Reserved |

Thus, a four bit value of 9 (nine) can indicate that the frame is a solicited trigger frame, of the type described in this disclosure.

Other bit fields can be used for the aforementioned purposes without deviating from the scope of this disclosure. And as mentioned above, a new frame structure can be defined for the MR-TF without deviating from the scope of this disclosure. The MR-TF indicates to the station(s) an acknowledgement of the U-LLP, and if available, resource allocation for low latency uplink transmissions for the preferred AC/TID, to be sent via TB PPDU.

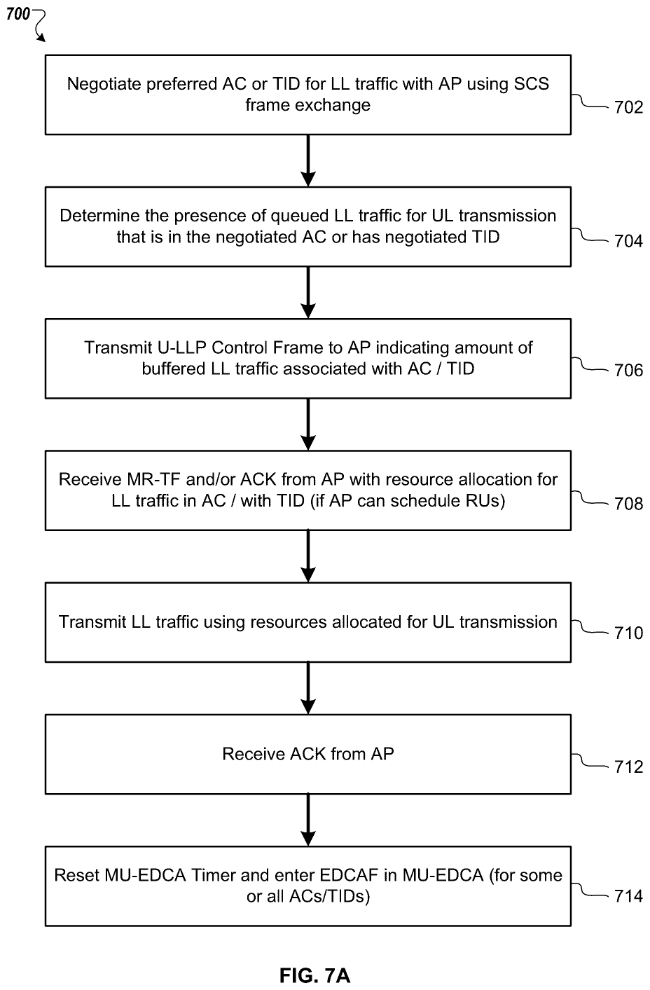

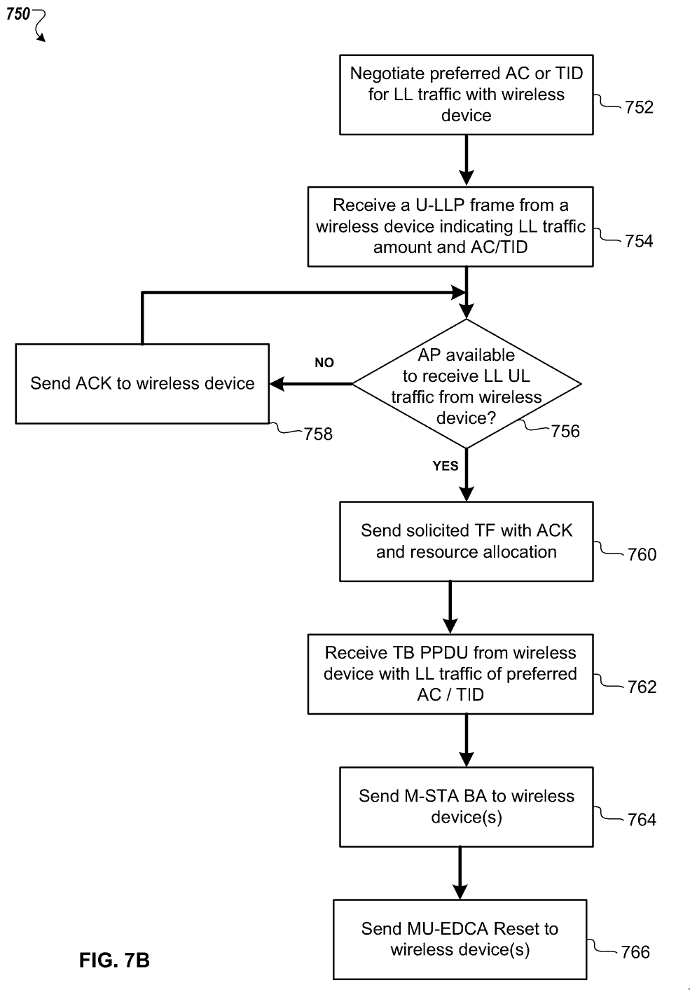

FIG. 7A is a process flow diagram for transmitting an unsolicited low latency presence frame for uplink transmissions during MU-EDCA operation in accordance with some implementations of the present disclosure. FIG. 7A illustrates a flowchart of an example method 700, according to some implementations. For clarity of presentation, the description that follows generally describes method 700 in the context of the other figures in this description. For example, method 700 can be performed by a wireless device of FIGS. 1-3, 5-6, and 8. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

At the outset, a wireless device can perform a negotiation (702) of a preferred AC or TID for low latency traffic with an AP. For example, a wireless device can exchange stream classification service (SCS) frames with an AP to perform the negotiation. The wireless device can determine (704) the presence of LL traffic for uplink transmission in the pre-negotiated AC or TID. This can occur during an MU-EDCA deferred contention period (i.e., while an MU-EDCA timer is running). The wireless device transmits (706) a U-LLP Control frame indicating amount of buffered LL data in this AC or TID.

The wireless device receives (708) from the AP an acknowledgment of the U-LLP. The acknowledgement could be within a solicited trigger frame or MR-TF. If the AP is unavailable to schedule uplink resources for the wireless device, the AP sends the acknowledgement without resource allocation. This acknowledgement could be sent in a solicited trigger frame (or MR-TF), and can be sent within the SIFS window.

If the AP is available to schedule the uplink, the AP sends the solicited trigger frame (or MR-TF) as a solicited response to U-LLP frame. MR-TF is analogous to the Basic TF with special signaling about preemption in Common Info field. The solicited trigger frame (or MR-TF) shall at least schedule the STA with elicited U-LLP frame. The AP may schedule RUsRUs to other STAs that have power management (PM)=0 (i.e., wireless device is awake and alert) and have pre-negotiated schedules service periods.

The wireless device can then transmit (710) the low latency traffic to the AP using the resources provided to the AP in the solicited trigger frame in a TB PPDU. The wireless device can receive (712) an ACK form the AP. The ACK can be in a M-STA BA, for example. On successful reception of ACK in M-STA BA for the TB PPDU (solicited only by a MR-TF) with LL data, the wireless device resets (714) MU-EDCA parameters (including MU-EDCA timer) for the AC or TID carrying LL traffic and continues EDCAF using EDCA parameters. EDCAF operation is invoked by the wireless device from here onwards till the time out duration set by the MR-TF expires.

If the STA receives an ACK in M-STA BA for a TB PPDU (solicited by a Basic TF), the STA resumes EDCA function using MU-EDCA parameters.

FIG. 7B illustrates a flowchart 750 of an example method performed by an access point, according to some implementations. At the outset, an access point can perform a negotiation (752) with a wireless device of the wireless device's preferred AC or TID for low latency traffic. The AP can receive (754) a U-LLP frame from the wireless device, the U-LLP frame including an amount of low latency traffic to send on the uplink and an identification of the AC/TID of the low latency traffic. The U-LLP frame is a solicitation by the wireless device for a trigger frame.

If the AP is unavailable (756) to schedule uplink traffic for the wireless device, the AP sends (758) an ACK to the wireless device. The AP can encode the ACK into a solicited trigger frame without providing resource allocation within the solicited trigger frame.

If the AP can schedule uplink resources, the AP sends (760) a solicited trigger frame to the wireless device. The solicited trigger frame can be an MR-TF. The solicited trigger frame includes an ACK of the U-LLP and resource allocation, among other details described above. The AP can then receive (762) a TB PPDU from the wireless device containing the low latency traffic of the AC/TID.

The solicited trigger frame also includes an EDCA timeout timer. In the time duration between M-STA BA and unless timeout timer expires, STA uses EDCAF with EDCA parameters (MU-EDCA TIMER is reset). Once the timeout timer expires, STA returns to MU-EDCA mode (invokes EDCAF using MU-EDCA parameters advertised in last Beacon frame received)

After receiving the TB PPDU, the AP sends (764) an M-STA BA to the wireless device for the TB PPDU. The AP sends (766) an MU-EDCA parameter reset to the wireless devices. The MU-EDCA parameter reset can be encoded into the M-STA BA or can be sent separately. The MU-EDCA parameter reset can cause the wireless devices to invoke EDCAF with MU-EDCA. The MU-EDCA parameters reset is sent specifically to the STA that sent the U-LLP and for which the AP sent a trigger frame. A unique reset is sent for each STA.

FIG. 8 illustrates a block diagram of an electronic device 800, according to some implementations. The electronic device 800 can be a cellular telephone, a smartwatch, an access point, a wireless speaker, an Internet-of-Things (IoT) device, among other examples. The electronic device 800 includes hardware resources 802 that include one or more processors (or processor cores) 810, one or more memory/storage devices 820, and one or more communication resources 830, each of which can be communicatively coupled via a bus 840.

The one or more processors 810 include one or more devices configured to perform computational operations. For example, the one or more processors 810 can include one or more microprocessors, application-specific integrated circuits (ASICs), microcontrollers, graphics processing units (GPUs), programmable-logic devices, and/or one or more digital signal processors (DSPs). The processors 810 can include, for example, a processor 812 and a processor 814. The processor(s) 810 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 can include main memory, disk storage, or any suitable combination thereof. The memory/storage devices 820 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 820 are coupled to one or more high-capacity mass-storage devices (not shown). In some examples, memory/storage devices 820 can be coupled to a magnetic or optical drive, a solid-state drive, or another type of mass-storage device. In these examples, the memory/storage devices 820 can be used by electronic device 800 as fast-access storage for often-used data, while the mass-storage device is used to store less frequently used data.

The communication resources 830 can include interconnection or network interface components or other suitable devices to communicate with one or more peripheral devices 804 or one or more databases 806 via a network 808. For example, the communication resources 830 can include wired communication components (e.g., for coupling via USB), cellular communication components, NFC components, Bluetooth® (or Bluetooth® Low Energy) components, Wi-Fi® components, and other communication components.

The communication resources 830 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 800 includes one or more nodes, e.g., a pad or a connector, which can be coupled to the set of antennas. Thus, electronic device 800 might or might not include the set of antennas. For example, communication resources 830 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 830 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 830 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 850 can include software, a program, an application, an applet, an app, or other executable code for causing at least any of the processors 810 to perform any one or more of the methodologies discussed herein. The instructions 850 can reside, completely or partially, within at least one of the processors 810 (e.g., within the processor's cache memory), the memory/storage devices 820, or any suitable combination thereof. In some implementations, any portion of the instructions 850 can be transferred to the hardware resources 802 from any combination of the peripheral devices 804 or the databases 806. Accordingly, the memory of processors 810, the memory/storage devices 820, the peripheral devices 804, and the databases 806 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 850, operating system (such as a driver for an interface circuit in communication resources 830) or in firmware in an interface circuit in communication resources 830. Additionally or alternatively, at least some of the operations in the communication techniques can be implemented in a physical layer, such as hardware in an interface circuit in communication resources 830. In some implementations, the communication techniques are implemented, at least in part, in a MAC layer and/or in a physical layer in an interface circuit in communication resources 830.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHZ, 2.4 GHz, 5 GHZ, 6 GHz, 60 GHz, and/or a band of frequencies used by a Citizens Broadband Radio Service, by LTE, 5G, or any other communication system.

Although specific components are used to describe electronic device 800, in some implementations, different components and/or subsystems can be present in electronic device 800. For example, electronic device 800 can include one or more additional processing subsystems, memory subsystems, networking subsystems, and/or display subsystems. Additionally, one or more of the subsystems might not be present in electronic device 800. In some implementations, electronic device 800 can include one or more additional subsystems that are not shown in FIG. 8. In some implementations, electronic device can include an analysis subsystem that performs at least some of the operations in the communication techniques. Although separate subsystems are shown in FIG. 8, in some implementations some or all of a given subsystem or component can be integrated into one or more of the other subsystems or component(s) in electronic device 800.

FIG. 9 is a schematic diagram 900 illustrating use of an unsolicited low latency presence (U-LLP) frame for soliciting a preemption trigger frame in accordance with some implementations of the present disclosure. In FIG. 9, an AP 202 may obtain channel access through a RTS (e.g., MU-RTS 902) and CTS (904) procedure. The AP 202 can send DL PPDU 906 during a period of time for DL transmission. During this time, the STA1 204 can receive low latency traffic for transmission (e.g., traffic of AC_VI in this example). The STA1 204 can configure a U-LLP message for requesting a trigger frame (TF). In some implementations, the trigger frame can be a basic trigger frame, a solicited trigger frame, or a solicited preemption trigger frame (SPTF). The STA1 204 can send the U-LLP message 910 with a compressed Block acknowledgement (C-BA) (together, C+BA/U-LLP message) to the access point.

As discussed above, the U-LLP can include reserved bits that indicate the type of solicited control frame. The STA1 204 can send the U-LLP message 910 to the AP 202. After receiving the u-LLP message 910 indicating a Solicited Trigger for TXOP Preemption, the AP 202 sends the Trigger frame (TF) 912 for the specific AC indicated in eliciting U-LLP Control field or frame to initiate an UL OFDMA session. In some implementations, instead of an AC, the indicated data is associated with a TID and the AP 202 sends a TF for the data associated with a specific TID.

The TF established a preempted trigger access period for the STA1 204 (because the STA1 is preempting the AP's channel access). The STA1 204 can then send a transport block 914 with a PPDU for the data with AC_VI. After receiving the transport block 914 with a PPDU for the data with AC_VI, the AP 202 sends a C-BA to the STA1 204. Traffic associated with other TIDs within the same AC still follows EDCA parameters, as well as traffic with other ACs.

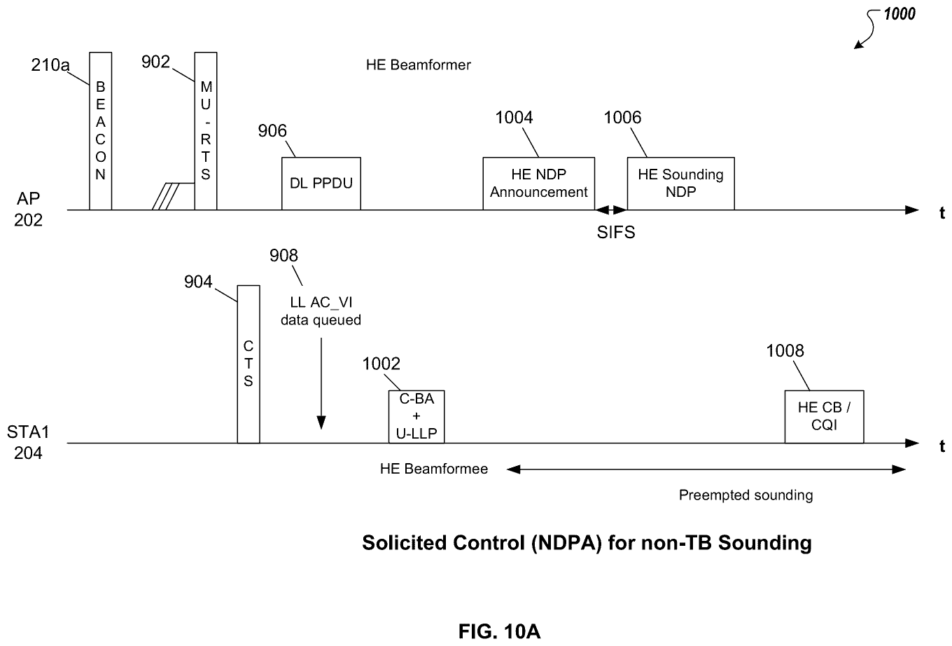

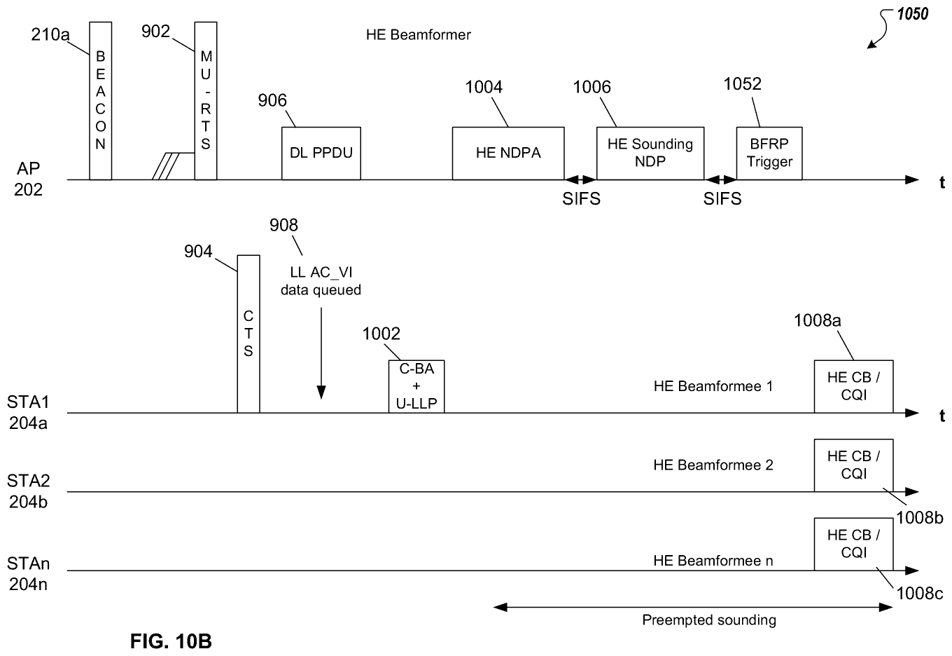

FIG. 10A is a schematic diagram 1000 illustrating use of an example unsolicited low latency presence (U-LLP) presence frame for soliciting a control frame for non-Trigger-based sounding in accordance with some implementations of the present disclosure. FIG. 10A illustrates an example of a single-user scenario, but can also be used in a multi-user scenario.

An AP 202 may obtain channel access through a RTS (e.g., MU-RTS 902) and CTS (904) procedure. The AP 202 can send DL PPDU 906 during a period of time for DL transmission. The STA1 204 can determine, e.g., from reference signals received in DL PPDU 206 or through other mechanisms, that the channel conditions warrant sounding. For example, STA1 204 experiences fast fading resulting in degraded reception performance (e.g., defined in some implementations as channel performance resulting in BA with multiple 0's in BA Bitmap). The STA1 204 can configure a U-LLP 1002 with information indicating a solicited request for channel sounding. STA1 204 can package the U-LLP (control) frame 1002 with a C-BA that is scheduled in response to DL PPDU 206 to the AP 202. The U-LLP 1002 is configured to solicit a control frame from the AP 202 to initiate sounding. After the AP 202 receives the U-LLP 1002, the AP 202 sends to the STA1 204 a solicited null data packet announcement (NDPA) 1004 to initiate ultra-high reliability (UHR) sounding. The AP 202 can then (after a SIFS period) send a sounding NDP 1006 to the STA1 204.

The solicited NDPA and Sounding NDPA establish (in response to the U-LLP 1002) a preempted sounding. The STA1 204 can perform a sounding procedure, including compressed beamforming or channel quality determination or other procedure. The STA1 can respond to the sounding NDP 1006 with a channel quality report, such as a compressed beamforming or channel quality indicator 1008 that the STA1 204 sends to the AP 202.

FIG. 10B is a schematic diagram 1050 illustrating use of an unsolicited low latency presence (U-LLP) presence frame for soliciting a control frame for Trigger-based sounding in accordance with some implementations of the present disclosure. FIG. 10B shows similar features as FIG. 10A. FIG. 10B illustrates a multi-user scenario, but can be used in a single user scenario. STA requests to initiate sounding to recompute a steering matrix for revised beam forming. In FIG. 10B, STA1 204a acts as a first beamformee (a beamformee is a recipient of a beam that is requesting sounding for improved beam forming from the another transmitting device), STA2 204b acts a second beamformee, and STAn 204n acts a nth beamformee. This is a multi-user scenario.

STA1 204a can determine to initiate channel sounding. STA1 204a, therefore, configures a U-LLP 1002 for requesting channel sounding. After the AP 202 receives the U-LLP 1002, the AP 202 sends a solicited null data packet announcement (NDPA) 1004 to initiate ultra-high reliability (UHR) sounding to one or more other stations, such as STA1 204a, STA2 204b, STAn 204n, and so on. After a SIFS period, the AP 202 can send a sounding NDP 1006 to the STA1 204a, STA2 204b, STAn 204n, and so forth. The AP 202 can also send a Beamforming Report Poll (BRFP) trigger frame 10502 to the STA1 204a, STA2 204b, STAn 204n, and so forth.

The transmission of the solicited null data packet announcement (NDPA) 1004 establishes a preempted sounding period for the STAs to perform sounding reporting. STA1 204a, STA2 204b, STAn 204n can perform a sounding procedure, and send the AP 202 CB/CQI reporting. STA1 204a can send a CB/CQI report 1008a, STA2 204b can send a CB/CQI report 1008b, STAn 204n can send a CB/CQI report 1008n, etc.

If STA1 204a is the only station requesting sounding, after the AP 202 sends the NDP announcement and NDP, STA1 204a can perform a sounding procedure, and send the AP 202 CB/CQI reporting. For SU sounding, the NDPA carries a single User Info field; for MU sounding, multiple User Info fields are included.

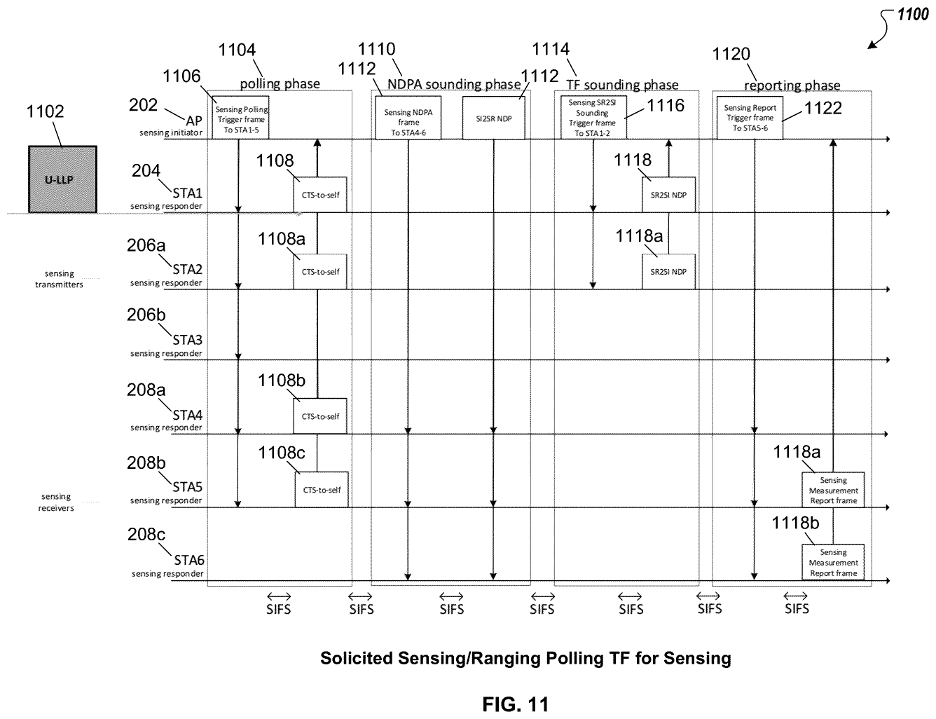

FIG. 11 is a schematic diagram 1100 illustrating use of an example unsolicited low latency presence (U-LLP) presence frame for soliciting a control frame for sensing or ranging in accordance with some implementations of the present disclosure. In FIG. 11, the STA1 204 uses U-LLP for Solicited polling Trigger frame for Ranging/Sensing. STA1 204 sends U-LLP (control) frame 1102 that solicits a Ranging/Sensing Polling Trigger frame (control) frame 1106 from AP 202 during a polling phase 1104 to initiate Trigger-based ranging or sensing. As an example, the STA may initiate ranging while in an indoor mall or initiate a sensing session for lighting control inside a room. These are only examples and other appropriate use cases are contemplated. Ranging or sensing can be a Trigger based process that polls either a single user or multiple users as in FIG. 11. In the case of a single user requesting a ranging or sensing session, STA1 sends a U-LLP frame that solicits a polling Trigger frame for Ranging/Sensing from AP 202. For this single user STA1, the User Info field in the polling Trigger frame contains a single User Info field with AID12 field matching the AID of STA1. The multi-user procedure can include one or more of the following operations.

The STA1 204 configures a U-LLP 1102 to include information indicating a request for ranging or sensing. The AP 202 can act as a ranging or sensing initiator and can initiate a polling phase 1104 of the ranging or sensing procedure for the STA1 204 (SU case) or for STA1 204, STA2 206a, STA3 206b, STA4 208a, STA5 208b, and STA6 206c, etc. (MU case).

The AP 202 can send a ranging polling trigger frame or sensing polling trigger frame 1106 (referred to hereinafter as ranging/sensing polling trigger frame 1106) to STA1 204 (and to one or more other STAs as appropriate). The ranging/sensing polling trigger frame 1106 can trigger the STA1 204 (and other STAs) to send CTS-to-self message 1108 (in the absence of RTS). After a SIFS period, for example, STA2 206a can send CTS-to-self message 1108a, STA3 206b, STA4 208a can send CTS-to-self message 1108b, STA5 208b can send CTS-to-self message 1108c, etc. STAs that do not send CTS-to-self frame might have their NAV set from an OBSS transmission and hence not allowed to transmit (with non-zero NAV set).

After a SIFS period, the AP 202, having received CTS-to-self from one or more STAs, can send a ranging NDPA frame or sensing NDPA frame 1112 to one or more STAs during the NDPA sounding phase 1110. After a SIFS period, the AP 202 can send a Sensing Initiator to Sensing Responder (SI2SR) NDP frame 1112 to the same STAs (similar to the NDPA).

After a SIFS period, and during the trigger frame sound phase 1114, the AP can send a ranging or sensing sensor responder to sensor initiator (SR2SI) trigger frame 1116 to STA1 204 and other STAs. STA1 204 can respond after a SIFS with an SR2SI NDP 1118. If STA2 206a receives an SR2SI trigger frame 1116, STA2 206a can also respond after a SIFS with an SR2SI NDP 1118a.

During the reporting phase 1120, the AP can send sensing report trigger frame 1122 to one or more other STAs, such as STA5 208b and STA6 208c. STA5 208b can send back sensing measurement report from 1118a, while STA6 208c can send back sensing measurement report from 1118b.

A similar sequence can be used for ranging, where “sensing” can be replaced with “ranging” for each of the frames in the shown sequence. For SU sounding, the NDPA carries a single User Info field; for MU sounding, multiple User Info fields are included.

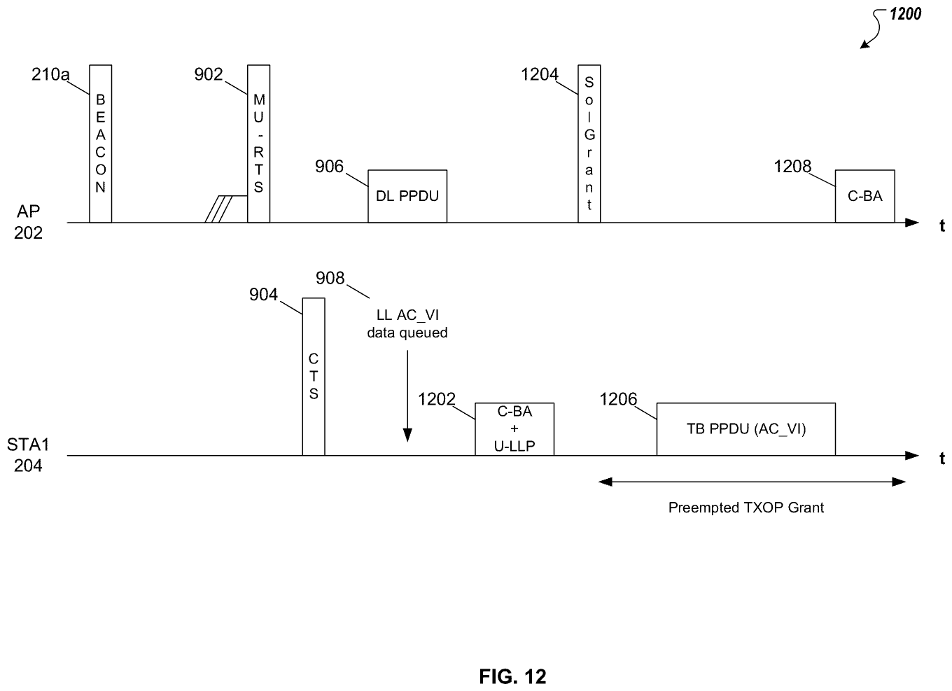

FIG. 12 is a schematic diagram 1200 illustrating use of an example unsolicited low latency presence (U-LLP) presence frame for soliciting a control frame for preempting a TXOP grant in accordance with some implementations of the present disclosure. FIG. 12 includes the same or similar feature as FIG. 9. The AP 202 sends DL PPDU during a TXOP. During the TXOP and while AP 202 is sending DL PPDU 906, the STA1 can receive LL traffic for transmission having AC_VI (for example). The STA1 204 can configure a U-LLP 1202 with information indicating a request for Solicited Control (Grant) for TXOP. The STA1 204 can package the U-LLP 1202 with a C-BA that STA1 204 sends to the AP 202 in response to receiving DL PPDU 906. The STA1 204 sends U-LLP (control) frame 1202 indicating non-zero buffer size in Queue size field, for example, or other information indicating the type of solicited preemption.

The AP 202 decodes the U-LLP 1202 and determines from the U-LLP that STA1 204 intends to (or is requesting to) send low latency data, and sends Solicited Grant frame 1204 after receiving U-LLP frame 1202. The Solicited Grant frame 1204 can grant the STA1 the remainder of the TXOP.

In one example, STA1 204 sends low latency data after sending a CTS frame in response to an RTS frame from AP 202; STA1 204 sends a U-LLP frame 1202 with non-zero value in Queue Size field, for example. The AP 202 sends a Solicited Grant frame 1204 indicating to STA1 204 that the remaining TXOP is granted to the STA1 204. The duration of the remaining TXOP granted to the STA1 204 is indicated in the Solicited Grant frame 1204. By granting the TXOP, the AP 202 may not have to specify that the grant is for a particular AC or TID; but the STA1 may encounter a problem if the TXOP length is insufficient to send the queued LL data.

The U-LLP frame 1202 can include a Queue Size field that the STA 204 can encode with information indicating how much queued data is available to send (e.g., the queued LL data). The AP 202 can use the Queue Size information to allocate the appropriate amount of TXOP duration necessary for the STA 204 to transmit the LL data. The AP 202 can include the TXOP duration information in the Duration field of the MAC header of the solicited grant frame 1204.

In a scenario where the TXOP duration available is insufficient for the STA 204 to send the entire LL data, the AP 202 can allocate the entire remaining portion of the TXOP to the STA 204. The STA 204 send as much of the LL data using the TXOP duration, and then use channel contention or other channel acquisition techniques to transmit the remaining portions of the buffered LL data.

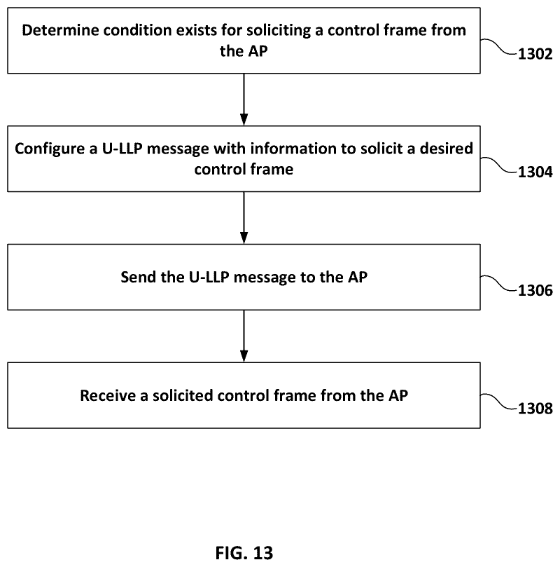

FIG. 13 is a process flowchart 1300 for using an example unsolicited low latency presence (U-LLP) frame for soliciting a control frame from an access point in accordance with some implementations of the present disclosure. At 1302, the wireless device can determine that a condition exists for soliciting a control frame from the access point. For example, the wireless device can determine that there is LL traffic queued during the AP's TXOP. Or the wireless device can determine that channel sounding or ranging/sensing is desired. Other conditions can also exist for the wireless device to determine to solicit a control frame to perform some operations.

At 1304, the wireless device configures an unsolicited low latency presence (U-LLP) message with information to solicit the desired control frame. For example, the U-LLP can be configured to request TXOP grant, to preempt current TXOP, to request sounding, or to request ranging/sensing. The wireless device can use a buffer size, queue size, or reserved bits to identify the desired solicited control frame.

At 1306, the wireless device can send the U-LLP message to the access point. The AP can decode the U-LLP as a solicitation of a control frame. The AP can determine whether and how to respond to the solicitation. The AP can send a solicited control frame of the desired type to the wireless device. At 308 wireless device can receive the solicited control frame, and perform some action in accordance. For example, the wireless device receiving a solicited grant control frame can take over the TXOP from the AP and send LL PPDU; or the wireless device receiving a sounding NDP or sounding trigger frame can perform sounding operations. Other examples are within the scope of this disclosure. In general, the wireless device can use a U-LLP to solicit a control frame from the AP to perform some functions, in particular, when the wireless device is seeking to preempt another on-going channel usage by another entity.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In the following sections, further exemplary embodiments are provided.

Example 1 includes method performed by a wireless device operating in an uplink multi-user mode, the method including determining that the wireless electronic device has low latency data to transmit to an access point using the uplink multi-user mode, the low latency data of a type defined by the AC or TID excluded from uplink multi-user mode; setting an exclusion bit in an operating mode control subfield of a transmit operating mode indicator frame, the bit indicating the exclusion of one access category (AC) or one traffic identifier (TID) from the uplink multi-user mode; sending a trigger-based PPDU to the AP with the transmit operating mode indicator frame; contending for channel access to send the low latency data on the uplink using enhanced distributed channel access (EDCA) function with EDCA parameters; and transmitting the low latency data to the access point using a single user PPDU using the EDCA-based channel contention.

Example 2 may include the subject matter of example 1, wherein the operating mode control subfield includes a bit field for each AC.

Example 3 may include the subject matter of example 1, wherein the operating mode control subfield includes a bit field for each TID.

Example 4 may include the subject matter of any of examples 1-3, wherein for the bit set in the operating mode control subfield, excluding traffic in the AC or with the TID from performing using trigger-based uplink multi-user mode transmissions.

Example 5 may include the subject matter of any of examples 1-4, wherein for the bit set in the operating mode control subfield, transmitting traffic in the AC or with the TID using a single-user mode transmission scheme.

Example 6 may include the subject matter of any of examples 1-5, wherein an uplink multi-user disable bit of the operating mode control subfield is set to 1.

Example 7 may include the subject matter of example 6, wherein the operating mode control subfield includes a bit map for each AC as follows:

| AC Bit | |
|---|---|
| Field | Interpretation |
| B0 = 1 | Trigger-based uplink multi-user (UL MU) transmissions for |
| | AC background are suspended by wireless electronic device; |
| | UL MU operation allowed for other ACs. |
| B1 = 1 | Trigger-based uplink multi-user (UL MU) transmissions for |
| | AC best effort are suspended by wireless electronic device; |
| | UL MU operation allowed for other ACs. |
| B2 = 1 | Trigger-based uplink multi-user (UL MU) transmissions for |
| | AC video are suspended by wireless electronic device; |
| | UL MU operation allowed for other ACs. |
| B3 = 1 | Trigger-based uplink multi-user (UL MU) transmissions for |
| | AC voice are suspended by wireless electronic device; |
| | UL MU operation allowed for other ACs. |

Example 8 may include the subject matter of example 6, wherein the operating mode control subfield includes a bit map for each TID as follows:

| AC Bit | |
|---|---|
| Field | Interpretation |
| B0 = 1 | Trigger-based uplink multi-user (UL MU) transmissions for |
| | TID 0 are suspended by wireless electronic device; UL MU |
| | operation allowed for other TIDs. |
| B1 = 1 | Trigger-based uplink multi-user (UL MU) transmissions for |
| | TID 1 are suspended by wireless electronic device; UL MU |
| | operation allowed for other TIDs. |
| B2 = 1 | Trigger-based uplink multi-user (UL MU) transmissions for |
| | TID 2 are suspended by wireless electronic device; UL MU |
| | operation allowed for other TIDs. |
| B3 = 1 | Trigger-based uplink multi-user (UL MU) transmissions for |
| | TID 3 are suspended by wireless electronic device; UL MU |
| | operation allowed for other TIDs. |
| B4 = 1 | Trigger-based uplink multi-user (UL MU) transmissions for |
| | TID 4 are suspended by wireless electronic device; UL MU |
| | operation allowed for other TIDs. |
| B5 = 1 | Trigger-based uplink multi-user (UL MU) transmissions for |
| | TID 5 are suspended by wireless electronic device; UL MU |
| | operation allowed for other TIDs. |
| B6 = 1 | Trigger-based uplink multi-user (UL MU) transmissions for |
| | TID 6 are suspended by wireless electronic device; UL MU |
| | operation allowed for other TIDs. |
| B7 = 1 | Trigger-based uplink multi-user (UL MU) transmissions for |
| | TID 7 are suspended by wireless electronic device; UL MU |
| | operation allowed for other TIDs. |

Example 9 may include the subject matter of any of examples 1-5, wherein an uplink multi-user data disable bit of the operating mode control subfield is set to 1.

Example 10 may include the subject matter of example 9, wherein the operating mode control subfield includes a bit map for each AC as follows:

| AC Bit | |
|---|---|
| Field | Interpretation |
| B0 = 1 | Basic trigger-based uplink multi-user transmissions for AC |
| | background are suspended by wireless electronic device; UL |
| | MU operation allowed for other ACs. |
| B1 = 1 | Basic trigger-based uplink multi-user transmissions for AC |
| | best effort are suspended by wireless electronic device; UL |
| | MU operation allowed for other ACs. |
| B2 = 1 | Basic trigger-based uplink multi-user transmissions for AC |
| | video are suspended by wireless electronic device; UL MU |
| | operation allowed for other ACs. |
| B3 = 1 | Basic trigger-based uplink multi-user transmissions for AC |
| | voice are suspended by wireless electronic device; UL MU |
| | operation allowed for other ACs. |

Example 11 may include the subject matter of example 9, wherein the operating mode control subfield includes a bit map for each TID as follows:

| AC | |
|---|---|
| Bit | |
| Field | Interpretation |
| B0 = 1 | Basic trigger-based uplink multi-user (UL MU) transmissions |
| | for TID 0 are suspended by wireless electronic device; |
| | UL MU operation allowed for other TIDs. |
| B1 = 1 | Basic trigger-based uplink multi-user (UL MU) transmissions |
| | for TID 1 are suspended by wireless electronic device; |
| | UL MU operation allowed for other TIDs. |
| B2 = 1 | Basic trigger-based uplink multi-user (UL MU) transmissions |
| | for TID 2 are suspended by wireless electronic device; |
| | UL MU operation allowed for other TIDs. |
| B3 = 1 | Basic trigger-based uplink multi-user (UL MU) transmissions |
| | for TID 3 are suspended by wireless electronic device; |
| | UL MU operation allowed for other TIDs. |
| B4 = 1 | Basic trigger-based uplink multi-user (UL MU) transmissions |
| | for TID 4 are suspended by wireless electronic device; |
| | UL MU operation allowed for other TIDs. |
| B5 = 1 | Basic trigger-based uplink multi-user (UL MU) transmissions |
| | for TID 5 are suspended by wireless electronic device; |
| | UL MU operation allowed for other TIDs. |
| B6 = 1 | Basic trigger-based uplink multi-user (UL MU) transmissions |
| | for TID 6 are suspended by wireless electronic device; |
| | UL MU operation allowed for other TIDs. |
| B7 = 1 | Basic trigger-based uplink multi-user (UL MU) transmissions |
| | for TID 7 are suspended by wireless electronic device; |
| | UL MU operation allowed for other TIDs. |

Example 12 may include the subject matter of any of examples 1-11, further including identifying a preferred AC or preferred TID and informing the access point of the preferred AC or preferred TID; determining a presence of low latency traffic queued for uplink transmission, the low latency traffic in the preferred AC or with the preferred TID; transmitting a control frame to the access point, the control frame including an indication of an amount of low latency traffic queued for uplink transmission and an identification of the AC or TID for the low latency traffic, the control frame being a request for uplink resources to transmit the low latency traffic; receiving a solicited trigger frame from the access point, the solicited trigger frame including either 1) acknowledgement of the control frame and an identification of uplink resources for transmitting the low latency traffic or 2) an acknowledgement of the control frame without an identification of uplink resources for transmitting the low latency traffic; and transmitting the low latency traffic using the uplink resources identified in the solicited trigger frame.

Example 13 may include the subject matter of example 12, further including receiving a block acknowledgement from the access point after transmitting the low latency traffic, the block acknowledgement including a multi-user enhanced distributed channel access (MU-EDCA) parameter reset, and the method includes resetting at least one MU-EDCA parameter.

Example 14 may include the subject matter of example 12, further including receiving a block acknowledgement from the access point; and after receiving the block acknowledgement, receiving an MU-EDCA reset frame from the access point.

Example 15 may include the subject matter of any of examples 13-14, wherein the MU-EDCA parameter reset includes an MU-EDCA timer reset, and the method includes resetting the MU-EDCA timer.

Example 16 may include the subject matter of any of examples 13-15, further including resetting one or more MU-EDCA parameters, including the MU-EDCA timer, and operating in an EDCA mode based on the EDCA parameters for at least the preferred access category identified in the control frame of the low latency traffic associated with the block acknowledgement.

Example 17 may include the subject matter of any of examples 12-16, wherein the solicited trigger frame includes a bit field for acknowledging the control frame, and the bit field for acknowledging the control frame being set to zero for acknowledging the control frame without providing uplink resources and the bit field being set to one for acknowledging the control frame and also providing uplink resources.

Example 18 may include the subject matter of example 17, wherein the solicited trigger frame includes a basic trigger frame, and wherein the bit field for acknowledging the control frame in the basic trigger frame is an uplink length subfield.

Example 19 may include the subject matter of example 17, wherein the solicited trigger frame further includes an ultra-high reliability mode trigger subfield that can indicate that the solicited trigger frame is an MU-EDCA trigger frame (MR-TF).

Example 20 may include the subject matter of any of examples 12-19, wherein the control frame includes a low latency buffer status field, the low latency buffer status field including subfields for one or more of low latency AC or TID, scaling factor, and low latency traffic queue size.

Example 21 may include the subject matter of example 20, wherein the control frame includes one low latency buffer status field for each preferred access category for which the wireless device has queued low latency traffic.

Example 22 may include the subject matter of any of examples 12-21, wherein the control frame includes an attempt to solicit a trigger frame during a short interframe space (SIFS) time period.

Example 23 may include the subject matter of any of examples 12-22, wherein the control frame includes an unsolicited low latency presence frame.

Example 24 is a method performed by a wireless device operating in an uplink multi-user mode, the method including identifying a preferred AC or preferred TID and informing the access point of the preferred AC or preferred TID; determining a presence of low latency traffic queued for uplink transmission, the low latency traffic in the preferred AC or with the preferred TID; transmitting an unsolicited low latency presence frame to the access point, the unsolicited low latency presence frame including an indication of an amount of low latency traffic queued for uplink transmission and an identification of the AC or TID for the low latency traffic, the unsolicited low latency presence frame being a request for uplink resources to transmit the low latency traffic; receiving a solicited trigger frame from the access point, the solicited trigger frame including either 1) acknowledgement of the unsolicited low latency presence frame and an identification of uplink resources for transmitting the low latency traffic or 2) an acknowledgement of the unsolicited low latency presence frame without an identification of uplink resources for transmitting the low latency traffic; and transmitting the low latency traffic using the uplink resources identified in the solicited trigger frame.

Example 25 may include the subject matter of example 24, further including receiving a block acknowledgement from the access point after transmitting the low latency traffic, the block acknowledgement including a multi-user enhanced distributed channel access MU-EDCA parameter reset, and the method includes resetting at least one MU-EDCA parameter.

Example 26 may include the subject matter of example 25, wherein the MU-EDCA parameter reset includes an MU-EDCA timer reset, and the method includes resetting the MU-EDCA timer.

Example 27 may include the subject matter of any of examples 25-26, wherein the MU-EDCA parameter reset causes the wireless device to enter into a deferred contention mode.

Example 28 may include the subject matter of any of examples 25-27, further including resetting one or more MU-EDCA parameters and operating in an EDCA mode based on the EDCA parameters for at least the preferred access category identified in the control frame of the low latency traffic associated with the block acknowledgement.

Example 29 may include the subject matter of any of examples 24-28, wherein the solicited trigger frame includes a bit field for acknowledging the unsolicited low latency presence frame, and the bit field for acknowledging the unsolicited low latency presence frame being set to zero for acknowledging the unsolicited low latency presence frame without providing uplink resources and the bit field being set to one for acknowledging the unsolicited low latency presence frame and also providing uplink resources.

Example 30 may include the subject matter of example 29, wherein the solicited trigger frame includes a basic trigger frame, and wherein the bit field for acknowledging the unsolicited low latency presence frame in the basic trigger frame is an uplink length subfield.

Example 31 may include the subject matter of example 29, wherein the solicited trigger frame further includes an ultra-high reliability mode trigger subfield that can indicate that the solicited trigger frame is an MU-EDCA trigger frame (MR-TF).

Example 32 may include the subject matter of any of examples 24-31, wherein the unsolicited low latency presence frame includes a low latency buffer status field, the low latency buffer status field including subfields for one or more of low latency AC or TID, scaling factor, and low latency traffic queue size.

Example 33 may include the subject matter of example 32, wherein the unsolicited low latency presence frame includes one low latency buffer status field for each preferred access category for which the wireless device has queued low latency traffic.

Example 34 may include the subject matter of any of examples 24-33, wherein the unsolicited low latency presence frame includes a solicitation for a trigger frame within a SIFS time period.

Example 35 may include the subject matter of any of examples 24-34, wherein the unsolicited low latency presence frame includes a solicitation to begin a solicited trigger mode (STM).

Example 36 is a wireless device including a processor and memory, and configured to perform any of the method steps described in claims 24-32.

Example 37 is a method performed by an access point, the method including receiving, from a wireless device, an unsolicited low latency presence (U-LLP) frame indicating a presence of low latency traffic for uplink transmission by a wireless device operating in multi-user enhanced distributed channel access (MU-EDCA) operating mode, the U-LLP identifying an access category (AC) or traffic identifier (TID) for the low latency traffic for uplink transmission and an amount of low latency traffic for uplink transmission; determining that the AC or TID is a pre-negotiated preferred AC or TID for the wireless device; determining whether the access point is available for uplink scheduling; if the access point is available for uplink scheduling for the wireless device, transmitting a solicited trigger frame to the wireless device that includes an acknowledgement of the U-LLP and a resource allocation for the wireless device to use to transmit the low latency traffic for uplink transmission; and if the access point is not available for uplink scheduling for the wireless device, transmitting an acknowledgement to the wireless device without a resource allocation.

Example 38 may include the subject matter of example, wherein the acknowledgement transmitted to the wireless device without the resource allocation is within a solicited trigger frame.

Example 39 may include the subject matter of any of examples 37-38, wherein the solicited trigger frame is an MU-EDCA Reset trigger frame (MR-TF).

Example 40 may include the subject matter of example, wherein the MR-TF includes a basic trigger frame and additional bit fields for ultra-high reliability (UHR) trigger to indicate that the basic trigger frame is an MR-TF.

Example 41 may include the subject matter of any of examples 37-40, wherein the solicited trigger frame includes a bit field to indicate one or more of trigger type, an acknowledgement of the U-LLP, approval or denial of solicited trigger mode, and resource allocation.

Example 42 may include the subject matter of any of examples 37-41, further including transmitting an MU-EDCA parameter reset in the solicited trigger frame.

Example 43 may include the subject matter of any of examples 37-41, further including receiving a trigger based (TB) PPDU from the wireless device with the low latency traffic of the preferred AC or preferred TID on the resources allocated to the wireless device by the solicited trigger frame.

Example 44 may include the subject matter of example 43, further including transmitting a multi-station block acknowledgement (M-STA BA) to the wireless device to acknowledge receipt of the TB PPDU.

Example 45. may include the subject matter of example 44, wherein the M-STA BA includes an MU-EDCA parameter reset.

Example 46 may include the subject matter of example 44, further including transmitting an MU-EDCA parameter reset to the wireless device after transmitting the M-STA BA.

Example 47 may include the subject matter of example 37-46, wherein the access point receiving the U-LLP triggers the access point to transmit at least an acknowledgement of the U-LLP to the wireless device during an MU-EDCA deferred contention period (while an MU-EDCA timer is running).

Example 48 may include the subject matter of any of examples 37-47, wherein the access point receiving the U-LLP triggers the access point to transmit at least an acknowledgement of the U-LLP to the wireless device during an MU-EDCA deferred contention period within a short interframe space (SIFS) period of time.

Example 49 may include the subject matter of any of examples 37-46, wherein the access point receiving the U-LLP triggers the access point to transmit a trigger frame with an acknowledgement to the wireless device during an MU-EDCA deferred contention period (while an MU-EDCA timer is running).

Example 50 may include the subject matter of any of examples 37-46 and 49, wherein the access point receiving the U-LLP triggers the access point to transmit a trigger frame with an acknowledgement to the wireless device during an MU-EDCA deferred contention period within a short interframe space (SIFS) period of time.

Example 51 may include the subject matter of any of examples 37-50, wherein the U-LLP is a request by the wireless device to begin a solicited trigger mode (STM).

Example 52 may include the subject matter of example 51, wherein the solicited trigger frame includes a bit field to indicate the approval or denial of the STM for the wireless device.

Example 53 is an access point configured to perform one or more operations described in claims 37-52.

Example 54 is an access point configured to perform one or more operations described in the specification.

Example 55 is wireless device including a processor and memory, and configured to perform any of the method steps described in claims 1-23.

Example 56 is a wireless device configured to perform one or more operations described in the specification.

Example 57 is a method performed by a wireless device operating in an uplink multi-user mode, the method including determining that a condition exists to prompt the wireless device to transmit an unsolicited low latency presence frame to an access point to solicit a solicited control frame to be sent to the wireless device from the access point; transmitting the unsolicited low latency presence frame to the access point, the unsolicited low latency presence frame including an indication of a type of solicited control frame requested by the wireless device; receiving a solicited control frame from the access point, the solicited control frame including information in response to the indication in the unsolicited low latency presence frame; and performing an action based on the received solicited control frame.

Example 58 may include the subject matter of example 57, wherein the condition includes the wireless device having received low latency data for transmission associated with an access category (AC) or traffic identifier (TID) that is exempted from EDCA operation, the wireless device having received the low latency uplink data during a TXOP for the access point; and wherein the unsolicited low latency presence frame is transmitted with a Block acknowledgement in response to receiving a downlink data unit from the access point during the TXOP, and wherein the unsolicited low latency presence frame includes an indication of the access category of the low latency data for transmission.

Example 59 may include the subject matter of example 58, further including receiving, from the access point, a trigger frame (TF) for the AC or TID identified in the unsolicited low latency presence frame, the TF initiating an opportunity for the wireless device to transmit the low latency data.

Example 60 may include the subject matter of example 57, wherein the condition includes the wireless device having received a data unit from the access point and the wireless device having determined that a channel quality between the wireless device and the access point is below a threshold; and the method including configuring a Block acknowledgement with multiple zeros to indicate poor channel quality, configuring the unsolicited low latency presence frame to request sounding from the access point, and sending the unsolicited low latency presence frame with the block acknowledgment to the access point in response to receiving the data unit.

Example 61 may include the subject matter of example 60, further including receiving, from the access point, a null data packet (NDP) announcement; receiving, from the access point, a sounding NDP; and transmitting, to the access point, a channel quality indicator based on the characteristics of the detected sounding NDP.

Example 62 may include the subject matter of example 61, wherein the sounding NDP is received after a SIFS period.

Example 63 may include the subject matter of example 61, wherein the NDP announcement includes a single unit information field for single-user mode or multiple user information fields for multi-user mode.

Example 64 may include the subject matter of example 61, further including receiving, after receiving the sounding NDP, a beamforming report poll (BFRP) trigger message, and wherein transmitting, to the access point, a channel quality indicator based on the characteristics of the detected sounding NDP and information in the BFRP trigger message.

Example 65 may include the subject matter of example 57, wherein the condition includes the wireless device determining to initiate ranging or sensing; the method including configuring the unsolicited low latency presence frame with information to request a solicited sensing or ranging polling trigger frame; and sending the unsolicited low latency presence frame with information to request a solicited sensing or ranging polling trigger frame to the access point; receiving, in response to the unsolicited low latency presence frame sent to the access point, a ranging or sensing polling trigger frame; and sending, in response to receiving the ranging or sensing polling trigger frame, a clear-to-send (CTS) message to the access point.

Example 66 may include the subject matter of example 65, wherein sending the CTS message to the access point causes the access point to send a ranging or sensing null data packet (NDP) announcement (NDPA) frame to the wireless device and/or other stations in proximity to the wireless device and a Sensing Initiator to Sensing Responder (SI2SR) NDP to one or more other stations in proximity to the wireless device.

Example 67 may include the subject matter of any of examples 65 or 66, further including receiving a ranging or sensing a Sensing Initiator to Sensing Responder (SI2SR) sounding trigger frame from the access point; and sending an SI2SR NDP to the access point.

Example 68 may include the subject matter of example 67, wherein sending an SI2SR NDP to the access point causes the access point to send a sensing report trigger frame to the wireless device and/or other stations in proximity to the wireless device, which causes the other stations to send sensing measurement reporting frames to the access point.

Example 69 may include the subject matter of any of examples 65-68, wherein, the CTS message includes a CTS-to-self message.

Example 70 may include the subject matter of any of examples 65-69, further including receiving from the access point, a sensing responder to sounding initiator trigger frame; and sending to the access point a sensing responder to sounding initiator null data packet.

Example 71 may include the subject matter of example 57, wherein the condition includes the wireless device having received low latency data for transmission, the wireless device having received the low latency uplink data during a TXOP for the access point; and wherein the unsolicited low latency presence frame is transmitted with a Block acknowledgement in response to receiving a downlink data unit from the access point during the TXOP, and wherein the unsolicited low latency presence frame includes an indication requesting a solicited grant of the TXOP.

Example 72 may include the subject matter of example 71, further including receiving, from the access point, a solicited grant control frame, the solicited grant control frame granting the wireless device a remaining portion of the TXOP duration; and sending the low latency data during the TXOP.

Example 73 is a wireless device including a processor and memory, and configured to perform any of the method steps described in claims 57-72.

Example 74 is a wireless device configured to perform one or more operations described in the specification.

Example 75 is a method performed by an access point including receiving an unsolicited low latency presence frame from a wireless device, the unsolicited low latency presence frame including information indicating a solicitation of a control frame; determining a solicited control frame requested by the wireless device by decoding the unsolicited low latency presence frame; configuring a control frame to send to the wireless device in response to the information in the unsolicited low latency presence frame; and sending the control frame to the wireless device.

Example 76 may include the subject matter of example 75, wherein the unsolicited low latency presence frame is received during a TXOP for the access point.

Example 77 may include the subject matter of any of examples 75 or 76, wherein the unsolicited low latency presence frame includes a request for a solicited trigger frame.

Example 78 may include the subject matter of any of examples 75 or 76, wherein the unsolicited low latency presence frame includes a request for a TXOP grant.

Example 79 may include the subject matter of any of examples 75 or 76, wherein the unsolicited low latency presence frame includes a request for a control frame to perform sounding.

Example 80 may include the subject matter of any of examples 75 or 76, wherein the unsolicited low latency presence frame includes a request for a control frame to perform sensing or ranging.

Example 81 is an access point including a processor and memory, and configured to perform any of the method steps described in claims 75-80.

Example 82 is an access point configured to perform one or more operations described in the specification.

Example 83 may include one or more non-transitory computer-readable media including instructions to cause an electronic device, upon execution of the instructions by one or more processors of the electronic device, to perform one or more elements of a method described in or related to any of examples 1-82, or any other method or process described herein.

Example 84 may include an apparatus including logic, modules, or circuitry to perform one or more elements of a method described in or related to any of examples 1-83, or any other method or process described herein.

Example 85 may include a method, technique, or process as described in or related to any of examples 1-84, or portions or parts thereof.

Example 86 may include an apparatus including: one or more processors and one or more computer-readable media including instructions that, when executed by the one or more processors, cause the one or more processors to perform the method, techniques, or process as described in or related to any of examples 1-85, or portions thereof.

Example 87 may include a signal as described in or related to any of examples 1-86, or portions or parts thereof.

Example 88 may include a datagram, information element, packet, frame, segment, PDU, or message as described in or related to any of examples 1-87, or portions or parts thereof, or otherwise described in the present disclosure.

Example 89 may include a signal encoded with data as described in or related to any of examples 1-88, or portions or parts thereof, or otherwise described in the present disclosure.

Example 90 may include a signal encoded with a datagram, IE, packet, frame, segment, PDU, or message as described in or related to any of examples 1-89, or portions or parts thereof, or otherwise described in the present disclosure.

Example 91 may include an electromagnetic signal carrying computer-readable instructions, wherein execution of the computer-readable instructions by one or more processors is to cause the one or more processors to perform the method, techniques, or process as described in or related to any of examples 1-90, or portions thereof.

Example 92 may include a computer program including instructions, wherein execution of the program by a processing element is to cause the processing element to carry out the method, techniques, or process as described in or related to any of examples 1-65, or portions thereof. The operations or actions performed by the instructions executed by the processing element can include the methods of any one of examples 1-91.

Example 93 may include a signal in a wireless network as shown and described herein.

Example 94 may include a method of communicating in a wireless network as shown and described herein.

Example 95 may include a system for providing wireless communication as shown and described herein. The operations or actions performed by the system can include the methods of any one of examples 1-94.

Example 96 may include a device for providing wireless communication as shown and described herein. The operations or actions performed by the device can include the methods of any one of examples 1-95.

The previously described examples 1-70 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station or access point, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-51.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
determining, by a wireless device operating in an uplink multi-user mode, that a condition exists to prompt transmitting an unsolicited low latency presence frame to an access point soliciting transmission of a solicited control frame from the access point; transmitting the unsolicited low latency presence frame to the access point, the unsolicited low latency presence frame comprising an indication of a type of solicited control frame requested by the wireless device;
receiving a solicited control frame from the access point, the solicited control frame comprising information relating to the unsolicited low latency presence frame; and
performing an action based on the received solicited control frame.

2. The method of claim 1, wherein:
the condition comprises the wireless device having received low latency uplink data for transmission, the low latency uplink data associated with an access category (AC) or traffic identifier (TID) that is exempted from enhanced distributed channel access (EDCA) operation, the wireless device having received the low latency uplink data during a transmission opportunity (TXOP) for the access point,
the unsolicited low latency presence frame is transmitted with a block acknowledgement in response to receiving a downlink data unit from the access point during the TXOP, and
the unsolicited low latency presence frame comprises an indication of the access category of the low latency uplink data for transmission.

3. The method of claim 2, further comprising:
receiving, from the access point, a trigger frame (TF) for the AC or TID identified in the unsolicited low latency presence frame, the TF initiating an opportunity for the wireless device to transmit the low latency uplink data.

4. The method of claim 1, wherein the condition comprises the wireless device having received a data unit from the access point and the wireless device having determined that a channel quality between the wireless device and the access point is below a threshold.

5. The method of claim 4, further comprising:
configuring a block acknowledgement to indicate a poor channel quality;
configuring the unsolicited low latency presence frame to request sounding from the access point; and
transmitting the unsolicited low latency presence frame with the block acknowledgment to the access point in response to receiving the data unit.

6. The method of claim 4, further comprising:
receiving, from the access point, a null data packet (NDP) announcement;
receiving, from the access point, a sounding NDP; and
transmitting, to the access point, a channel quality indicator based on one or more characteristics of the sounding NDP.

7. The method of claim 6, wherein the sounding NDP is received after a short interframe space (SIFS) period.

8. The method of claim 6, wherein the NDP announcement comprises a single unit information field for single-user mode or multiple user information fields for multi-user mode.

9. The method of claim 6, further comprising:
receiving, after receiving the sounding NDP, a beamforming report poll (BFRP) trigger message, wherein transmission of the channel quality indicator is based on the one or more characteristics of the sounding NDP and the BFRP trigger message.

10. The method of claim 1, wherein the condition comprises the wireless device determining to initiate ranging or sensing, the method further comprising:
transmitting, to the access point, the unsolicited low latency presence frame with information to request a solicited sensing or ranging polling trigger frame;
receiving, in response to the unsolicited low latency presence frame, a ranging or sensing polling trigger frame; and
transmitting, in response to receiving the ranging or sensing polling trigger frame, a clear-to-send (CTS) message.

11. The method of claim 10, further comprising:
receiving a Sensing Initiator to Sensing Responder (SI2SR) sounding trigger frame from the access point; and
transmitting an SI2SR NDP to the access point.

12. The method of claim 10, wherein the CTS message comprises a CTS-to-self message.

13. The method of claim 10, further comprising:
receiving, from the access point, a sensing responder to sounding initiator trigger frame; and
transmitting, to the access point, a sensing responder to sounding initiator null data packet (NDP).

14. The method of claim 1, wherein the condition comprises the wireless device having received low latency data for transmission, the wireless device having received the low latency data during a transmission opportunity (TXOP) for the access point.

15. The method of claim 14, wherein the unsolicited low latency presence frame is transmitted with a block acknowledgement in response to receiving a downlink data unit from the access point during the TXOP, and wherein the unsolicited low latency presence frame comprises an indication requesting a solicited grant of the TXOP.

16. The method of claim 14, further comprising:
receiving, from the access point, a solicited grant control frame, the solicited grant control frame granting the wireless device a remaining portion of the TXOP; and
transmitting the low latency data during the TXOP.

17. A method performed by an access point, the method comprising:
receiving an unsolicited low latency presence frame from a wireless device, the unsolicited low latency presence frame comprising information indicating a solicitation of a control frame;
determining a solicited control frame requested by the wireless device based on the unsolicited low latency presence frame;
transmitting a control frame to the wireless device based on the unsolicited low latency presence frame.

18. The method of claim 17, wherein the unsolicited low latency presence frame is received during a TXOP for the access point.

19. An apparatus of baseband processor circuitry configured to perform operations comprising:
determining that a condition exists to cause transmission of an unsolicited low latency presence frame soliciting transmission of a solicited control frame from an access point;
causing transmission of the unsolicited low latency presence frame, the unsolicited low latency presence frame comprising an indication of a type of solicited control frame requested;
receiving an indication of the solicited control frame, the solicited control frame comprising information relating to the unsolicited low latency presence frame; and
performing an action based on the solicited control frame.

20. The apparatus of claim 19, wherein:
the condition comprises receiving low latency uplink data for transmission, the low latency uplink data associated with an access category (AC) or traffic identifier (TID) that is exempted from enhanced distributed channel access (EDCA) operation, the low latency uplink being received data during a transmission opportunity (TXOP) for the access point,
the unsolicited low latency presence frame is transmitted with a block acknowledgement in response to receiving a downlink data unit from the access point during the TXOP, and
the unsolicited low latency presence frame comprises an indication of the access category of the low latency uplink data for transmission.
